(19) United States
(12) Patent Application Publication
(10) Pub. No.: US 2026/0067901 A1
(43) Pub. Date: Mar. 5, 2026

(54) SIDELINK SYNCHRONIZATION SIGNAL BLOCK FOR COVERAGE ENHANCEMENT IN UNLICENSED SPECTRUM

(71) Applicant: QUALCOMM Incorporated, San Diego, CA (US)

(72) Inventors: Chih-Hao LIU, San Diego, CA (US); Stelios STEFANATOS, San Diego, CA (US); Jing SUN, San Diego, CA (US); Giovanni CHISCI, San Diego, CA (US)

(21) Appl. No.: 19/103,525

(22) PCT Filed: Sep. 18, 2023
(86) PCT No.: PCT/US2023/074493

§ 371 Date: Feb. 12, 2025

(30) Foreign Application Priority Data
Sep. 21, 2022 (GR) 20220100772

(51) Int. Cl. H04W 72/25; H04B 10/293

(52) U.S. Cl. CPC H04W 72/25; H04B 10/2931

(57) ABSTRACT

Disclosed are systems and techniques for wireless communications. For instance, a first network device for wireless communications may include at least one memory comprising instructions and at least one processor coupled to the memory. The at least one processor may be configured to generate a sidelink synchronization block (S-SSB), the S-SSB including at least two sidelink primary synchronization signal (SPSS) symbols and transmit, to a second network device, the generated S-SSB.

### FIELD

The present disclosure generally relates to wireless communications. For example, aspects of the present disclosure relate to systems and techniques for a sidelink synchronization signal block (S-SSB) for coverage enhancement in unlicensed spectrum (e.g., shared spectrum).

### BACKGROUND

Wireless communications systems are deployed to provide various telecommunications and data services, including telephony, video, data, messaging, and broadcasts. Broadband wireless communications systems have developed through various generations, including a first-generation analog wireless phone service (1G), a second-generation (2G) digital wireless phone service (including interim 2.5G networks), a third-generation (3G) high speed data, Internet-capable wireless device, and a fourth-generation (4G) service (e.g., Long-Term Evolution (LTE), WiMax). Examples of wireless communications systems include code division multiple access (CDMA) systems, time division multiple access (TDMA) systems, frequency division multiple access (FDMA) systems, orthogonal frequency division multiple access (OFDMA) systems, Global System for Mobile communication (GSM) systems, etc. Other wireless communications technologies include 802.11 Wi-Fi, Bluetooth, among others.

A fifth-generation (5G) mobile standard calls for higher data transfer speeds, greater number of connections, and better coverage, among other improvements. The 5G standard (also referred to as “New Radio” or “NR”), according to Next Generation Mobile Networks Alliance, is designed to provide data rates of several tens of megabits per second to each of tens of thousands of users, with 1 gigabit per second to tens of workers on an office floor. Several hundreds of thousands of simultaneous connections should be supported in order to support large sensor deployments.

Although wireless communication systems have made great technological advancements over many years, challenges still exist. For example, complex and dynamic environments can still attenuate or block signals between wireless transmitters and wireless receivers, undermining a throughput a wireless device is able to achieve to a particular wireless network, given the wireless nodes that can be used to access the wireless network. Consequently, an ability of a wireless device, such as user equipment (UE) to select from multiple wireless networks, such from among a 5G and another wireless network, or from among multiple 5G networks should be enhanced.

### SUMMARY

The following presents a simplified summary relating to one or more aspects disclosed herein. Thus, the following summary should not be considered an extensive overview relating to all contemplated aspects, nor should the following summary be considered to identify key or critical elements relating to all contemplated aspects or to delineate the scope associated with any particular aspect. Accordingly, the following summary presents certain concepts relating to one or more aspects relating to the mechanisms disclosed herein in a simplified form to precede the detailed description presented below.

Disclosed are systems, methods, apparatuses, and computer-readable media for performing wireless communications. In one illustrative example, first network device for wireless communications is provided. The first network device includes at least one memory comprising instructions and at least one processor coupled to the memory. The at least one processor is configured to: generate a sidelink synchronization block (S-SSB), the S-SSB including at least two sidelink primary synchronization signal (SPSS) symbols and transmit, to a second network device, the generated S-SSB.

In another example, a first network device for wireless communications is provided. The first network device includes at least one memory comprising instructions and at least one processor coupled to the at least one memory. The at least one processor is configured to: receive, form a second network device, a sidelink synchronization block (S-SSB), the S-SSB including at least two sidelink primary synchronization signal (SPSS) symbols; and decode at least one of the two SPSS symbols to obtain at least one of timing information or frequency information.

As another example, a method for wireless communications is provided, comprising: generating a sidelink synchronization block (S-SSB), the S-SSB including at least two sidelink primary synchronization signal (SPSS) symbols; and transmitting, to a second network device, the generated S-SSB.

In another example, a method for wireless communications is provided, comprising: receiving, form a second network device, a sidelink synchronization block (S-SSB), the S-SSB including at least two sidelink primary synchronization signal (SPSS) symbols; and decoding at least one of the two SPSS symbols to obtain at least one of timing information or frequency information.

As another example, a non-transitory computer-readable medium is provided having stored thereon instructions that, when executed by at least one processor, cause the at least one processor to: generate a sidelink synchronization block (S-SSB), the S-SSB including at least two sidelink primary synchronization signal (SPSS) symbols and transmit, to a second network device, the generated S-SSB.

In another example, a non-transitory computer-readable medium is provided having stored thereon instructions that, when executed by at least one processor, cause the at least one processor to: receive, form a second network device, a sidelink synchronization block (S-SSB), the S-SSB including at least two sidelink primary synchronization signal (SPSS) symbols; and decode at least one of the two SPSS symbols to obtain at least one of timing information or frequency information.

As another example, an apparatus for wireless communications is provided, comprising: means for generating a sidelink synchronization block (S-SSB), the S-SSB including at least two sidelink primary synchronization signal (SPSS) symbols; and means for transmitting, to a second network device, the generated S-SSB.

As another example, an apparatus for wireless communications is provided, comprising: means for receiving, form a second network device, a sidelink synchronization block (S-SSB), the S-SSB including at least two sidelink primary synchronization signal (SPSS) symbols; and means for decoding at least one of the two SPSS symbols to obtain at least one of timing information or frequency information.

Aspects generally include a method, apparatus, system, computer program product, non-transitory computer-readable medium, user equipment, base station, wireless communication device, and/or processing system as substantially described herein with reference to and as illustrated by the drawings and specification.

The foregoing has outlined rather broadly the features and technical advantages of examples according to the disclosure in order that the detailed description that follows may be better understood. Additional features and advantages will be described hereinafter. The conception and specific examples disclosed may be readily utilized as a basis for modifying or designing other structures for carrying out the same purposes of the present disclosure. Such equivalent constructions do not depart from the scope of the appended claims. Characteristics of the concepts disclosed herein, both their organization and method of operation, together with associated advantages, will be better understood from the following description when considered in connection with the accompanying figures. Each of the figures is provided for the purposes of illustration and description, and not as a definition of the limits of the claims.

While aspects are described in the present disclosure by illustration to some examples, those skilled in the art will understand that such aspects may be implemented in many different arrangements and scenarios. Techniques described herein may be implemented using different platform types, devices, systems, shapes, sizes, and/or packaging arrangements. For example, some aspects may be implemented via integrated chip embodiments or other non-module-component based devices (e.g., end-user devices, vehicles, communication devices, computing devices, industrial equipment, retail/purchasing devices, medical devices, and/or artificial intelligence devices). Aspects may be implemented in chip-level components, modular components, non-modular components, non-chip-level components, device-level components, and/or system-level components. Devices incorporating described aspects and features may include additional components and features for implementation and practice of claimed and described aspects. For example, transmission and reception of wireless signals may include one or more components for analog and digital purposes (e.g., hardware components including antennas, radio frequency (RF) chains, power amplifiers, modulators, buffers, processors, interleavers, adders, and/or summers). In some aspects, one or more of the apparatuses described herein can include, can be, or can be part of a mobile device (e.g., a mobile telephone or so-called “smart phone”, a tablet computer, or other type of mobile device), a network-connected wearable device, an extended reality device (e.g., a virtual reality (VR) device, an augmented reality (AR) device, or a mixed reality (MR) device), a personal computer, a laptop computer, a server computer (e.g., a video server or other server device), a television, a vehicle (or a computing device or system of a vehicle), a camera (e.g., a digital camera, an Internet Protocol (IP) camera, etc.), a multi-camera system, a robotics device or system, an aviation device or system, or other device. It is intended that aspects described herein may be practiced in a wide variety of devices, components, systems, distributed arrangements, and/or end-user devices of varying size, shape, and constitution.

Other objects and advantages associated with the aspects disclosed herein will be apparent to those skilled in the art based on the accompanying drawings and detailed description.

### BRIEF DESCRIPTION OF THE DRAWINGS

Examples of various implementations are described in detail below with reference to the following figures:

FIG. 1 is a block diagram illustrating an example of a wireless communication network, in accordance with some examples;

FIG. 2 is a diagram illustrating a design of a base station and a User Equipment (UE) device that enable transmission and processing of signals exchanged between the UE and the base station, in accordance with some examples;

FIG. 3 is a diagram illustrating an example of a disaggregated base station, in accordance with some examples;

FIG. 4 is a block diagram illustrating components of a user equipment, in accordance with some examples;

FIGS. 5A-5D depict various example aspects of data structures for a wireless communication network, in accordance with some examples;

FIG. 6 illustrates an example of a wireless communications system that supports S-SSB designs for shared spectrum, in accordance with aspects of the present disclosure;

FIG. 7 illustrates an example S-SSB, in accordance with aspects of the present disclosure;

FIG. 8 illustrates an example enhanced S-SSB with multiple SPSS symbols, in accordance with aspects of the present disclosure;

FIGS. 9A-9C illustrates examples of enhanced S-SSBs with multiple SPSS symbols and multiple SSSS symbols, in accordance with aspects of the present disclosure;

FIG. 10 illustrates an example enhanced S-SSB multiple SPSS symbols, multiple SSSS symbols, and expanded PSBCH, in accordance with aspects of the present disclosure;

FIG. 11 illustrates an example of an S-SSB multiplexed with a PSCCH/PSSCH, in accordance with aspects of the present disclosure;

FIG. 12 illustrates an example of an S-SSB having a separate S-SSB AGC symbol multiplexed with a PSCCH/PSSCH, in accordance with aspects of the present disclosure;

FIG. 13 is a flow diagram illustrating an example of a process for wireless communications, in accordance with aspects of the present disclosure;

FIG. 14 is a flow diagram illustrating an example of a process for wireless communications, in accordance with aspects of the present disclosure;

FIG. 15. is a diagram illustrating an example of a computing system, according to aspects of the present disclosure.

### DETAILED DESCRIPTION

Certain aspects and embodiments of this disclosure are provided below. Some of these aspects and embodiments may be applied independently and some of them may be applied in combination as would be apparent to those of skill in the art. In the following description, for the purposes of explanation, specific details are set forth in order to provide a thorough understanding of embodiments of the application. However, it will be apparent that various embodiments may be practiced without these specific details. The figures and description are not intended to be restrictive.

The ensuing description provides example embodiments only, and is not intended to limit the scope, applicability, or configuration of the disclosure. Rather, the ensuing description of the exemplary embodiments will provide those skilled in the art with an enabling description for implementing an exemplary embodiment. It should be understood that various changes may be made in the function and arrangement of elements without departing from the spirit and scope of the application as set forth in the appended claims.

As noted above, techniques and systems are described herein for a sidelink synchronization block (S-SSB) for coverage enhancement. Sidelink connections help enable multiple UEs to discover each other and communicate without requiring infrastructure support (e.g., from a base station, such as a 3GPP gNodeB (gNB)). To help UEs discover each other, a first UE may transmit an S-SSB that a second UE can detect and use to establish a connection with the first UE. The S-SSB may include a sidelink primary synchronization signal (SPSS) and a sidelink secondary synchronization signal (SSSS), and in some cases other signals. The SPSS may be used to provide coarse timing and frequency information to help detect the SSSS, which can provide a physical cell identifier (ID) for connecting to the first UE. In some cases, such as where the second UE is relatively far away or a relative motion between the first UE and second UE is high, detecting an SPSS in an S-SSB may be difficult. According to aspects described herein, the S-SSB may be enhanced to make detecting the SPSS easier. In one example, adding a second SPSS signal and/or a second SSSS can make it easier for another UE, such as the second UE, to detect and establish a sidelink connection.

Additional aspects of the present disclosure are described in more detail below.

Wireless networks are deployed to provide various communication services, such as voice, video, packet data, messaging, broadcast, and the like. A wireless network may support both access links for communication between wireless devices. An access link may refer to any communication link between a client device (e.g., a user equipment (UE), a station (STA), or other client device) and a base station (e.g., a gNB for 5G/NR, a 3GPP eNodeB (eNB) for LTE, a Wi-Fi access point (AP), or other base station) or a component of a disaggregated base station (e.g., a central unit, a distributed unit, and/or a radio unit). In one example, an access link between a UE and a 3GPP gNB may be over a Uu interface. In some cases, an access link may support uplink signaling, downlink signaling, connection procedures, etc.

In some aspects, wireless communications networks may be implemented using one or more modulation schemes. For example, a wireless communication network may be implemented using a quadrature amplitude modulation (QAM) scheme such as 16 QAM, 32 QAM, 64 QAM, etc.

As used herein, the terms “user equipment” (UE) and “network entity” are not intended to be specific or otherwise limited to any particular radio access technology (RAT), unless otherwise noted. In general, a UE may be any wireless communication device (e.g., a mobile phone, router, tablet computer, laptop computer, and/or tracking device, etc.), wearable (e.g., smartwatch, smart-glasses, wearable ring, and/or an extended reality (XR) device such as a virtual reality (VR) headset, an augmented reality (AR) headset or glasses, or a mixed reality (MR) headset), vehicle (e.g., automobile, motorcycle, bicycle, etc.), and/or Internet of Things (IoT) device, etc., used by a user to communicate over a wireless communications network. A UE may be mobile or may (e.g., at certain times) be stationary, and may communicate with a radio access network (RAN). As used herein, the term “UE” may be referred to interchangeably as an “access terminal” or “AT,” a “client device,” a “wireless device,” a “subscriber device,” a “subscriber terminal,” a “subscriber station,” a “user terminal” or “UT,” a “mobile device,” a “mobile terminal,” a “mobile station,” or variations thereof. Generally, UEs may communicate with a core network via a RAN, and through the core network the UEs may be connected with external networks such as the Internet and with other UEs. Of course, other mechanisms of connecting to the core network and/or the Internet are also possible for the UEs, such as over wired access networks, wireless local area network (WLAN) networks (e.g., based on IEEE 802.11 communication standards, etc.) and so on.

A network entity may be implemented in an aggregated or monolithic base station architecture, or alternatively, in a disaggregated base station architecture, and may include one or more of a central unit (CU), a distributed unit (DU), a radio unit (RU), a Near-Real Time (Near-RT) RAN Intelligent Controller (RIC), or a Non-Real Time (Non-RT) RIC. A base station (e.g., with an aggregated/monolithic base station architecture or disaggregated base station architecture) may operate according to one of several RATs in communication with UEs depending on the network in which it is deployed, and may be alternatively referred to as an access point (AP), a network node, a NodeB (NB), an evolved NodeB (eNB), a next generation eNB (ng-eNB), a New Radio (NR) Node B (also referred to as a gNB or gNodeB), etc. A base station may be used primarily to support wireless access by UEs, including supporting data, voice, and/or signaling connections for the supported UEs. In some systems, a base station may provide edge node signaling functions while in other systems it may provide additional control and/or network management functions. A communication link through which UEs may send signals to a base station is called an uplink (UL) channel (e.g., a reverse traffic channel, a reverse control channel, an access channel, etc.). A communication link through which the base station may send signals to UEs is called a downlink (DL) or forward link channel (e.g., a paging channel, a control channel, a broadcast channel, or a forward traffic channel, etc.). The term traffic channel (TCH), as used herein, may refer to either an uplink, reverse or downlink, and/or a forward traffic channel.

The term “network entity” or “base station” (e.g., with an aggregated/monolithic base station architecture or disaggregated base station architecture) may refer to a single physical transmit receive point (TRP) or to multiple physical TRPs that may or may not be co-located. For example, where the term “network entity” or “base station” refers to a single physical TRP, the physical TRP may be an antenna of the base station corresponding to a cell (or several cell sectors) of the base station. Where the term “network entity” or “base station” refers to multiple co-located physical TRPs, the physical TRPs may be an array of antennas (e.g., as in a multiple-input multiple-output (MIMO) system or where the base station employs beamforming) of the base station. Where the term “base station” refers to multiple non-co-located physical TRPs, the physical TRPs may be a distributed antenna system (DAS) (a network of spatially separated antennas connected to a common source via a transport medium) or a remote radio head (RRH) (a remote base station connected to a serving base station). Alternatively, the non-co-located physical TRPs may be the serving base station receiving the measurement report from the UE and a neighbor base station whose reference radio frequency (RF) signals (or simply “reference signals”) the UE is measuring. Because a TRP is the point from which a base station transmits and receives wireless signals, as used herein, references to transmission from or reception at a base station are to be understood as referring to a particular TRP of the base station.

In some implementations that support positioning of UEs, a network entity or base station may not support wireless access by UEs (e.g., may not support data, voice, and/or signaling connections for UEs), but may instead transmit reference signals to UEs to be measured by the UEs, and/or may receive and measure signals transmitted by the UEs. Such a base station may be referred to as a positioning beacon (e.g., when transmitting signals to UEs) and/or as a location measurement unit (e.g., when receiving and measuring signals from UEs).

An RF signal comprises an electromagnetic wave of a given frequency that transports information through the space between a transmitter and a receiver. As used herein, a transmitter may transmit a single “RF signal” or multiple “RF signals” to a receiver. However, the receiver may receive multiple “RF signals” corresponding to each transmitted RF signal due to the propagation characteristics of RF signals through multipath channels. The same transmitted RF signal on different paths between the transmitter and receiver may be referred to as a “multipath” RF signal. As used herein, an RF signal may also be referred to as a “wireless signal” or simply a “signal” where it is clear from the context that the term “signal” refers to a wireless signal or an RF signal.

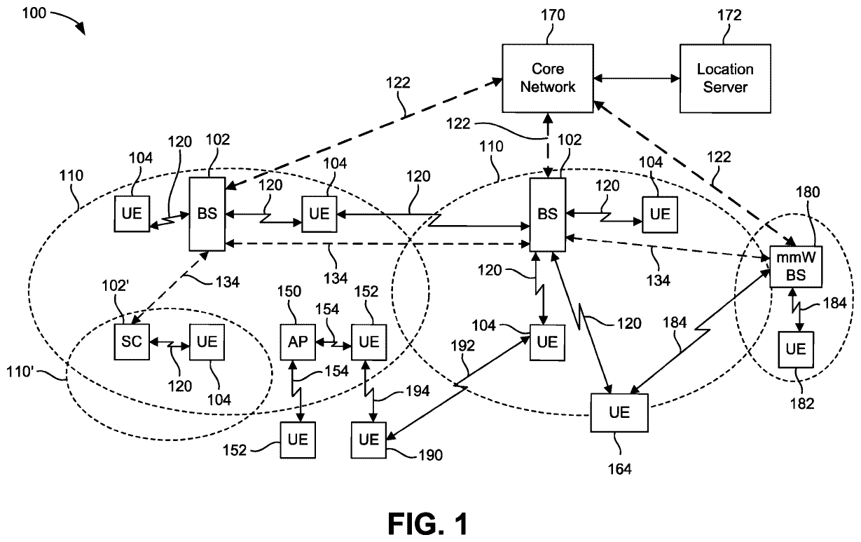

Various aspects of the systems and techniques described herein will be discussed below with respect to the figures. According to various aspects, FIG. 1 illustrates an example of a wireless communications system 100. The wireless communications system 100 (which may also be referred to as a wireless wide area network (WWAN)) may include various base stations 102 and various UEs 104. In some aspects, the base stations 102 may also be referred to as “network entities” or “network nodes.” One or more of the base stations 102 may be implemented in an aggregated or monolithic base station architecture. Additionally, or alternatively, one or more of the base stations 102 may be implemented in a disaggregated base station architecture, and may include one or more of a central unit (CU), a distributed unit (DU), a radio unit (RU), a Near-Real Time (Near-RT) RAN Intelligent Controller (RIC), or a Non-Real Time (Non-RT) RIC. The base stations 102 may include macro cell base stations (high power cellular base stations) and/or small cell base stations (low power cellular base stations). In an aspect, the macro cell base station may include eNBs and/or ng-eNBs where the wireless communications system 100 corresponds to a long term evolution (LTE) network, or gNBs where the wireless communications system 100 corresponds to a NR network, or a combination of both, and the small cell base stations may include femtocells, picocells, microcells, etc.

The base stations 102 may collectively form a RAN and interface with a core network 170 (e.g., an evolved packet core (EPC) or a 5G core (5GC)) through backhaul links 122, and through the core network 170 to one or more location servers 172 (which may be part of core network 170 or may be external to core network 170). In addition to other functions, the base stations 102 may perform functions that relate to one or more of transferring user data, radio channel ciphering and deciphering, integrity protection, header compression, mobility control functions (e.g., handover, dual connectivity), inter-cell interference coordination, connection setup and release, load balancing, distribution for non-access stratum (NAS) messages, NAS node selection, synchronization, RAN sharing, multimedia broadcast multicast service (MBMS), subscriber and equipment trace, RAN information management (RIM), paging, positioning, and delivery of warning messages. The base stations 102 may communicate with each other directly or indirectly (e.g., through the EPC or 5GC) over backhaul links 134, which may be wired and/or wireless.

The base stations 102 may wirelessly communicate with the UEs 104. Each of the base stations 102 may provide communication coverage for a respective geographic coverage area 110. In an aspect, one or more cells may be supported by a base station 102 in each coverage area 110. A “cell” is a logical communication entity used for communication with a base station (e.g., over some frequency resource, referred to as a carrier frequency, component carrier, carrier, band, or the like), and may be associated with an identifier (e.g., a physical cell identifier (PCI), a virtual cell identifier (VCI), a cell global identifier (CGI)) for distinguishing cells operating via the same or a different carrier frequency. In some cases, different cells may be configured according to different protocol types (e.g., machine-type communication (MTC), narrowband IoT (NB-IoT), enhanced mobile broadband (eMBB), or others) that may provide access for different types of UEs. Because a cell is supported by a specific base station, the term “cell” may refer to either or both of the logical communication entity and the base station that supports it, depending on the context. In addition, because a TRP is typically the physical transmission point of a cell, the terms “cell” and “TRP” may be used interchangeably. In some cases, the term “cell” may also refer to a geographic coverage area of a base station (e.g., a sector), insofar as a carrier frequency may be detected and used for communication within some portion of geographic coverage areas 110.

While neighboring macro cell base station 102 geographic coverage areas 110 may partially overlap (e.g., in a handover region), some of the geographic coverage areas 110 may be substantially overlapped by a larger geographic coverage area 110. For example, a small cell base station 102′ may have a coverage area 110′ that substantially overlaps with the coverage area 110 of one or more macro cell base stations 102. A network that includes both small cell and macro cell base stations may be known as a heterogeneous network. A heterogeneous network may also include home eNBs (HeNBs), which may provide service to a restricted group known as a closed subscriber group (CSG).

The communication links 120 between the base stations 102 and the UEs 104 may include uplink (also referred to as reverse link) transmissions from a UE 104 to a base station 102 and/or downlink (also referred to as forward link) transmissions from a base station 102 to a UE 104. The communication links 120 may use MIMO antenna technology, including spatial multiplexing, beamforming, and/or transmit diversity. The communication links 120 may be through one or more carrier frequencies. Allocation of carriers may be asymmetric with respect to downlink and uplink (e.g., more or less carriers may be allocated for downlink than for uplink).

The wireless communications system 100 may further include a WLAN AP 150 in communication with WLAN stations (STAs) 152 via communication links 154 in an unlicensed frequency spectrum (e.g., 5 Gigahertz (GHz)). When communicating in an unlicensed frequency spectrum, the WLAN STAs 152 and/or the WLAN AP 150 may perform a clear channel assessment (CCA) or listen before talk (LBT) procedure prior to communicating in order to determine whether the channel is available. In some examples, the wireless communications system 100 may include devices (e.g., UEs, etc.) that communicate with one or more UEs 104, base stations 102, APs 150, etc. utilizing the ultra-wideband (UWB) spectrum. The UWB spectrum may range from 3.1 to 10.5 GHz.

The small cell base station 102′ may operate in a licensed and/or an unlicensed frequency spectrum. When operating in an unlicensed frequency spectrum, the small cell base station 102′ may employ LTE or NR technology and use the same 5 GHz unlicensed frequency spectrum as used by the WLAN AP 150. The small cell base station 102′, employing LTE and/or 5G in an unlicensed frequency spectrum, may boost coverage to and/or increase capacity of the access network. NR in unlicensed spectrum may be referred to as NR-U. LTE in an unlicensed spectrum may be referred to as LTE-U, licensed assisted access (LAA), or MulteFire.

The wireless communications system 100 may further include a millimeter wave (mmW) base station 180 that may operate in mmW frequencies and/or near mmW frequencies in communication with a UE 182. The mmW base station 180 may be implemented in an aggregated or monolithic base station architecture, or alternatively, in a disaggregated base station architecture (e.g., including one or more of a CU, a DU, a RU, a Near-RT RIC, or a Non-RT RIC). Extremely high frequency (EHF) is part of the RF in the electromagnetic spectrum. EHF has a range of 30 GHz to 300 GHz and a wavelength between 1 millimeter and 10 millimeters. Radio waves in this band may be referred to as a millimeter wave. Near mmW may extend down to a frequency of 3 GHz with a wavelength of 100 millimeters. The super high frequency (SHF) band extends between 3 GHz and 30 GHz, also referred to as centimeter wave. Communications using the mmW and/or near mm W radio frequency band have high path loss and a relatively short range. The mmW base station 180 and the UE 182 may utilize beamforming (transmit and/or receive) over an mmW communication link 184 to compensate for the extremely high path loss and short range. Further, it will be appreciated that in alternative configurations, one or more base stations 102 may also transmit using mmW or near mmW and beamforming. Accordingly, it will be appreciated that the foregoing illustrations are merely examples and should not be construed to limit the various aspects disclosed herein.

In some aspects relating to 5G, the frequency spectrum in which wireless network nodes or entities (e.g., base stations 102/180, UEs 104/182) operate is divided into multiple frequency ranges, FR1 (from 450 to 6000 Megahertz (MHz)), FR2 (from 24250 to 52600 MHz), FR3 (above 52600 MHZ), and FR4 (between FR1 and FR2). In a multi-carrier system, such as 5G, one of the carrier frequencies is referred to as the “primary carrier” or “anchor carrier” or “primary serving cell” or “PCell,” and the remaining carrier frequencies are referred to as “secondary carriers” or “secondary serving cells” or “SCells.” In carrier aggregation, the anchor carrier is the carrier operating on the primary frequency (e.g., FR1) utilized by a UE 104/182 and the cell in which the UE 104/182 either performs the initial radio resource control (RRC) connection establishment procedure or initiates the RRC connection re-establishment procedure. The primary carrier carries all common and UE-specific control channels and may be a carrier in a licensed frequency (however, this is not always the case). A secondary carrier is a carrier operating on a second frequency (e.g., FR2) that may be configured once the RRC connection is established between the UE 104 and the anchor carrier and that may be used to provide additional radio resources. In some cases, the secondary carrier may be a carrier in an unlicensed frequency. The secondary carrier may contain only necessary signaling information and signals, for example, those that are UE-specific may not be present in the secondary carrier, since both primary uplink and downlink carriers are typically UE-specific. This means that different UEs 104/182 in a cell may have different downlink primary carriers. The same is true for the uplink primary carriers. The network is able to change the primary carrier of any UE 104/182 at any time. This is done, for example, to balance the load on different carriers. Because a “serving cell” (whether a PCell or an SCell) corresponds to a carrier frequency and/or component carrier over which some base station is communicating, the term “cell,” “serving cell,” “component carrier,” “carrier frequency,” and the like may be used interchangeably.

For example, still referring to FIG. 1, one of the frequencies utilized by the macro cell base stations 102 may be an anchor carrier (or “PCell”) and other frequencies utilized by the macro cell base stations 102 and/or the mmW base station 180 may be secondary carriers (“SCells”). In carrier aggregation, the base stations 102 and/or the UEs 104 may use spectrum up to Y MHz (e.g., 5, 10, 15, 20, 100 MHz) bandwidth per carrier up to a total of Yx MHz (x component carriers) for transmission in each direction. The component carriers may or may not be adjacent to each other on the frequency spectrum. Allocation of carriers may be asymmetric with respect to the downlink and uplink (e.g., more or less carriers may be allocated for downlink than for uplink). The simultaneous transmission and/or reception of multiple carriers enables the UE 104/182 to significantly increase its data transmission and/or reception rates. For example, two 20 MHz aggregated carriers in a multi-carrier system would theoretically lead to a two-fold increase in data rate (i.e., 40 MHz), compared to that attained by a single 20 MHz carrier.

In order to operate on multiple carrier frequencies, a base station 102 and/or a UE 104 may be equipped with multiple receivers and/or transmitters. For example, a UE 104 may have two receivers, “Receiver 1” and “Receiver 2,” where “Receiver 1” is a multi-band receiver that may be tuned to band (i.e., carrier frequency) ‘X’ or band ‘Y,’ and “Receiver 2” is a one-band receiver tuneable to band ‘Z’ only. In this example, if the UE 104 is being served in band ‘X,’ band ‘X’ would be referred to as the PCell or the active carrier frequency, and “Receiver 1” would need to tune from band ‘X’ to band ‘Y’ (an SCell) in order to measure band ‘Y’ (and vice versa). In contrast, whether the UE 104 is being served in band ‘X’ or band ‘Y,’ because of the separate “Receiver 2,” the UE 104 may measure band ‘Z’ without interrupting the service on band ‘X’ or band ‘Y.’

The wireless communications system 100 may further include a UE 164 that may communicate with a macro cell base station 102 over a communication link 120 and/or the mmW base station 180 over an mmW communication link 184. For example, the macro cell base station 102 may support a PCell and one or more SCells for the UE 164 and the mmW base station 180 may support one or more SCells for the UE 164.

The wireless communications system 100 may further include one or more UEs, such as UE 190, that connects indirectly to one or more communication networks via one or more device-to-device (D2D) peer-to-peer (P2P) links (referred to as “sidelinks”). In the example of FIG. 1, UE 190 has a D2D P2P link 192 with one of the UEs 104 connected to one of the base stations 102 (e.g., through which UE 190 may indirectly obtain cellular connectivity) and a D2D P2P link 194 with WLAN STA 152 connected to the WLAN AP 150 (through which UE 190 may indirectly obtain WLAN-based Internet connectivity). In an example, the D2D P2P links 192 and 194 may be supported with any well-known D2D RAT, such as LTE Direct (LTE-D), Wi-Fi Direct (Wi-Fi-D), Bluetooth®, and so on.

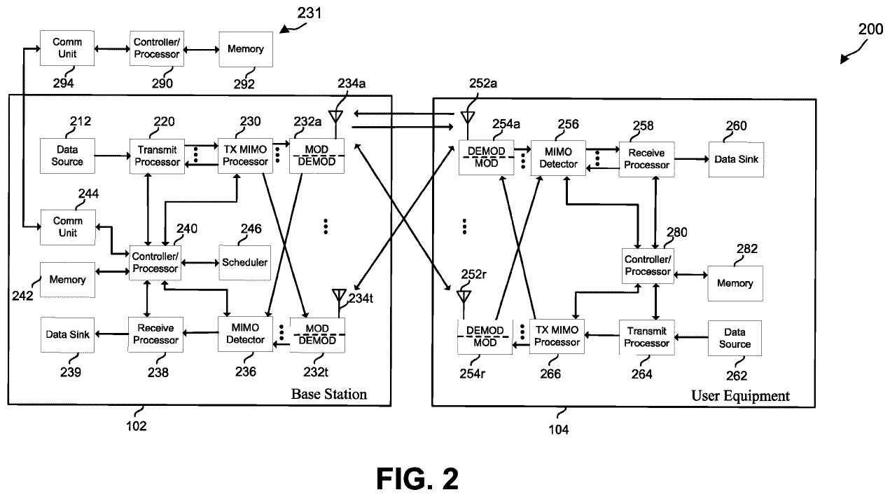

FIG. 2 shows a block diagram of a design of a base station 102 and a UE 104 that enable transmission and processing of signals exchanged between the UE and the base station, in accordance with some aspects of the present disclosure. Design 200 includes components of a base station 102 and a UE 104, which may be one of the base stations 102 and one of the UEs 104 in FIG. 1. Base station 102 may be equipped with T antennas 234a through 234t, and UE 104 may be equipped with R antennas 252a through 252r, where in general T≥1 and R≥1.

At base station 102, a transmit processor 220 may receive data from a data source 212 for one or more UEs, select one or more modulation and coding schemes (MCS) for each UE based at least in part on channel quality indicators (CQIs) received from the UE, process (e.g., encode and modulate) the data for each UE based at least in part on the MCS(s) selected for the UE, and provide data symbols for all UEs. Transmit processor 220 may also process system information (e.g., for semi-static resource partitioning information (SRPI) and/or the like) and control information (e.g., CQI requests, grants, upper layer signaling, and/or the like) and provide overhead symbols and control symbols. Transmit processor 220 may also generate reference symbols for reference signals (e.g., the cell-specific reference signal (CRS)) and synchronization signals (e.g., the primary synchronization signal (PSS) and secondary synchronization signal (SSS)). A transmit (TX) multiple-input multiple-output (MIMO) processor 230 may perform spatial processing (e.g., precoding) on the data symbols, the control symbols, the overhead symbols, and/or the reference symbols, if applicable, and may provide T output symbol streams to T modulators (MODs) 232a through 232t. The modulators 232a through 232t are shown as a combined modulator-demodulator (MOD-DEMOD). In some cases, the modulators and demodulators may be separate components. Each modulator of the modulators 232a to 232t may process a respective output symbol stream, e.g., for an orthogonal frequency-division multiplexing (OFDM) scheme and/or the like, to obtain an output sample stream. Each modulator of the modulators 232a to 232t may further process (e.g., convert to analog, amplify, filter, and upconvert) the output sample stream to obtain a downlink signal. T downlink signals may be transmitted from modulators 232a to 232t via T antennas 234a through 234t, respectively. According to certain aspects described in more detail below, the synchronization signals may be generated with location encoding to convey additional information.

At UE 104, antennas 252a through 252r may receive the downlink signals from base station 102 and/or other base stations and may provide received signals to demodulators (DEMODs) 254a through 254r, respectively. The demodulators 254a through 254r are shown as a combined modulator-demodulator (MOD-DEMOD). In some cases, the modulators and demodulators may be separate components. Each demodulator of the demodulators 254a through 254r may condition (e.g., filter, amplify, downconvert, and digitize) a received signal to obtain input samples. Each demodulator of the demodulators 254a through 254r may further process the input samples (e.g., for OFDM and/or the like) to obtain received symbols. A MIMO detector 256 may obtain received symbols from all R demodulators 254a through 254r, perform MIMO detection on the received symbols if applicable, and provide detected symbols. A receive processor 258 may process (e.g., demodulate and decode) the detected symbols, provide decoded data for UE 104 to a data sink 260, and provide decoded control information and system information to a controller/processor 280. A channel processor may determine reference signal received power (RSRP), received signal strength indicator (RSSI), reference signal received quality (RSRQ), channel quality indicator (CQI), and/or the like.

On the uplink, at UE 104, a transmit processor 264 may receive and process data from a data source 262 and control information (e.g., for reports comprising RSRP, RSSI, RSRQ, CQI, and/or the like) from controller/processor 280. Transmit processor 264 may also generate reference symbols for one or more reference signals (e.g., based at least in part on a beta value or a set of beta values associated with the one or more reference signals). The symbols from transmit processor 264 may be precoded by a TX-MIMO processor 266 if application, further processed by modulators 254a through 254r (e.g., for DFT-s-OFDM, CP-OFDM, and/or the like), and transmitted to base station 102. At base station 102, the uplink signals from UE 104 and other UEs may be received by antennas 234a through 234t, processed by demodulators 232a through 232t, detected by a MIMO detector 236 if applicable, and further processed by a receive processor 238 to obtain decoded data and control information sent by UE 104. Receive processor 238 may provide the decoded data to a data sink 239 and the decoded control information to controller (processor) 240. Base station 102 may include communication unit 244 and communicate to a network controller 231 via communication unit 244. Network controller 231 may include communication unit 294, controller/processor 290, and memory 292.

In some aspects, one or more components of UE 104 may be included in a housing. Controller 240 of base station 102, controller/processor 280 of UE 104, and/or any other component(s) of FIG. 2 may perform one or more techniques associated with implicit UCI beta value determination for NR.

Memories 242 and 282 may store data and program codes for the base station 102 and the UE 104, respectively. A scheduler 246 may schedule UEs for data transmission on the downlink, uplink, and/or sidelink.

In some aspects, deployment of communication systems, such as 5G new radio (NR) systems, may be arranged in multiple manners with various components or constituent parts. In a 5G NR system, or network, a network node, a network entity, a mobility element of a network, a radio access network (RAN) node, a core network node, a network element, or a network equipment, such as a base station (BS), or one or more units (or one or more components) performing base station functionality, may be implemented in an aggregated or disaggregated architecture. For example, a BS (such as a Node B (NB), evolved NB (eNB), NR BS, 5G NB, access point (AP), a transmit receive point (TRP), or a cell, etc.) may be implemented as an aggregated base station (also known as a standalone BS or a monolithic BS) or a disaggregated base station.

An aggregated base station may be configured to utilize a radio protocol stack that is physically or logically integrated within a single RAN node. A disaggregated base station may be configured to utilize a protocol stack that is physically or logically distributed among two or more units (such as one or more central or centralized units (CUs), one or more distributed units (DUs), or one or more radio units (RUs)). In some aspects, a CU may be implemented within a RAN node, and one or more DUs may be co-located with the CU, or alternatively, may be geographically or virtually distributed throughout one or multiple other RAN nodes. The DUs may be implemented to communicate with one or more RUs. Each of the CU, DU and RU also may be implemented as virtual units, i.e., a virtual central unit (VCU), a virtual distributed unit (VDU), or a virtual radio unit (VRU).

Base station-type operation or network design may consider aggregation characteristics of base station functionality. For example, disaggregated base stations may be utilized in an integrated access backhaul (IAB) network, an open radio access network (O-RAN (such as the network configuration sponsored by the O-RAN Alliance)), or a virtualized radio access network (vRAN, also known as a cloud radio access network (C-RAN)). Disaggregation may include distributing functionality across two or more units at various physical locations, as well as distributing functionality for at least one unit virtually, which may enable flexibility in network design. The various units of the disaggregated base station, or disaggregated RAN architecture, may be configured for wired or wireless communication with at least one other unit.

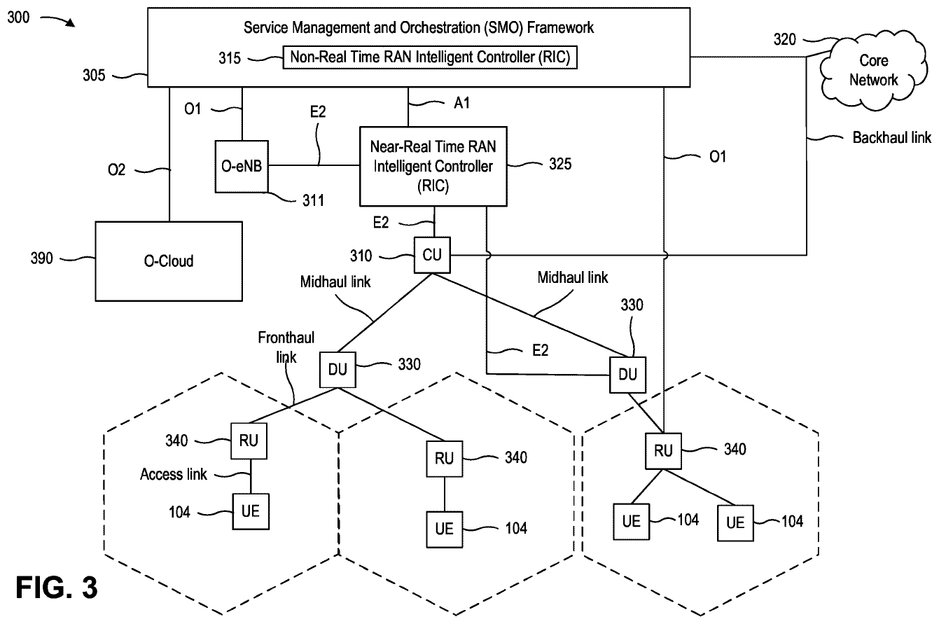

FIG. 3 shows a diagram illustrating an example disaggregated base station 300 architecture. The disaggregated base station 300 architecture may include one or more central units (CUs) 310 that may communicate directly with a core network 320 via a backhaul link, or indirectly with the core network 320 through one or more disaggregated base station units (such as a Near-Real Time (Near-RT) RAN Intelligent Controller (RIC) 325 via an E2 link, or a Non-Real Time (Non-RT) RIC 315 associated with a Service Management and Orchestration (SMO) Framework 305, or both). A CU 310 may communicate with one or more distributed units (DUs) 330 via respective midhaul links, such as an F1 interface. The DUs 330 may communicate with one or more radio units (RUs) 340 via respective fronthaul links. The RUs 340 may communicate with respective UEs 104 via one or more radio frequency (RF) access links. In some implementations, the UE 104 may be simultaneously served by multiple RUs 340.

Each of the units, e.g., the CUS 310, the DUs 330, the RUs 340, as well as the Near-RT RICs 325, the Non-RT RICs 315 and the SMO Framework 305, may include one or more interfaces or be coupled to one or more interfaces configured to receive or transmit signals, data, or information (collectively, signals) via a wired or wireless transmission medium. Each of the units, or an associated processor or controller providing instructions to the communication interfaces of the units, may be configured to communicate with one or more of the other units via the transmission medium. For example, the units may include a wired interface configured to receive or transmit signals over a wired transmission medium to one or more of the other units. Additionally, the units may include a wireless interface, which may include a receiver, a transmitter or transceiver (such as a radio frequency (RF) transceiver), configured to receive or transmit signals, or both, over a wireless transmission medium to one or more of the other units.

In some aspects, the CU 310 may host one or more higher layer control functions. Such control functions may include radio resource control (RRC), packet data convergence protocol (PDCP), service data adaptation protocol (SDAP), or the like. Each control function may be implemented with an interface configured to communicate signals with other control functions hosted by the CU 310. The CU 310 may be configured to handle user plane functionality (i.e., Central Unit-User Plane (CU-UP)), control plane functionality (i.e., Central Unit-Control Plane (CU-CP)), or a combination thereof. In some implementations, the CU 310 may be logically split into one or more CU-UP units and one or more CU-CP units. The CU-UP unit may communicate bidirectionally with the CU-CP unit via an interface, such as the E1 interface when implemented in an O-RAN configuration. The CU 310 may be implemented to communicate with the DU 330, as necessary, for network control and signaling.

The DU 330 may correspond to a logical unit that includes one or more base station functions to control the operation of one or more RUs 340. In some aspects, the DU 330 may host one or more of a radio link control (RLC) layer, a medium access control (MAC) layer, and one or more high physical (PHY) layers (such as modules for forward error correction (FEC) encoding and decoding, scrambling, modulation and demodulation, or the like) depending, at least in part, on a functional split, such as those defined by the 3rd Generation Partnership Project (3GPP). In some aspects, the DU 330 may further host one or more low PHY layers. Each layer (or module) may be implemented with an interface configured to communicate signals with other layers (and modules) hosted by the DU 330, or with the control functions hosted by the CU 310.

Lower-layer functionality may be implemented by one or more RUs 340. In some deployments, an RU 340, controlled by a DU 330, may correspond to a logical node that hosts RF processing functions, or low-PHY layer functions (such as performing fast Fourier transform (FFT), inverse FFT (iFFT), digital beamforming, physical random access channel (PRACH) extraction and filtering, or the like), or both, based at least in part on the functional split, such as a lower layer functional split. In such an architecture, the RU(s) 340 may be implemented to handle over the air (OTA) communication with one or more UEs 104. In some implementations, real-time and non-real-time aspects of control and user plane communication with the RU(s) 340 may be controlled by the corresponding DU 330. In some scenarios, this configuration may enable the DU(s) 330 and the CU 310 to be implemented in a cloud-based RAN architecture, such as a vRAN architecture.

The SMO Framework 305 may be configured to support RAN deployment and provisioning of non-virtualized and virtualized network elements. For non-virtualized network elements, the SMO Framework 305 may be configured to support the deployment of dedicated physical resources for RAN coverage requirements which may be managed via an operations and maintenance interface (such as an Ol interface). For virtualized network elements, the SMO Framework 305 may be configured to interact with a cloud computing platform (such as an open cloud (O-Cloud) 390) to perform network element life cycle management (such as to instantiate virtualized network elements) via a cloud computing platform interface (such as an O2 interface). Such virtualized network elements may include, but are not limited to, CUs 310, DUs 330, RUs 340 and Near-RT RICs 325. In some implementations, the SMO Framework 305 may communicate with a hardware aspect of a 4G RAN, such as an open eNB (O-eNB) 311, via an O1 interface. Additionally, in some implementations, the SMO Framework 305 may communicate directly with one or more RUs 340 via an O1 interface. The SMO Framework 305 also may include a Non-RT RIC 315 configured to support functionality of the SMO Framework 305.

The Non-RT RIC 315 may be configured to include a logical function that enables non-real-time control and optimization of RAN elements and resources, Artificial Intelligence/Machine Learning (AI/ML) workflows including model training and updates, or policy-based guidance of applications/features in the Near-RT RIC 325. The Non-RT RIC 315 may be coupled to or communicate with (such as via an A1 interface) the Near-RT RIC 325. The Near-RT RIC 325 may be configured to include a logical function that enables near-real-time control and optimization of RAN elements and resources via data collection and actions over an interface (such as via an E2 interface) connecting one or more CUs 310, one or more DUs 330, or both, as well as an O-eNB, with the Near-RT RIC 325.

In some implementations, to generate AI/ML models to be deployed in the Near-RT RIC 325, the Non-RT RIC 315 may receive parameters or external enrichment information from external servers. Such information may be utilized by the Near-RT RIC 325 and may be received at the SMO Framework 305 or the Non-RT RIC 315 from non-network data sources or from network functions. In some examples, the Non-RT RIC 315 or the Near-RT RIC 325 may be configured to tune RAN behavior or performance. For example, the Non-RT RIC 315 may monitor long-term trends and patterns for performance and employ AI/ML models to perform corrective actions through the SMO Framework 305 (such as reconfiguration via O1) or via creation of RAN management policies (such as A1 policies).

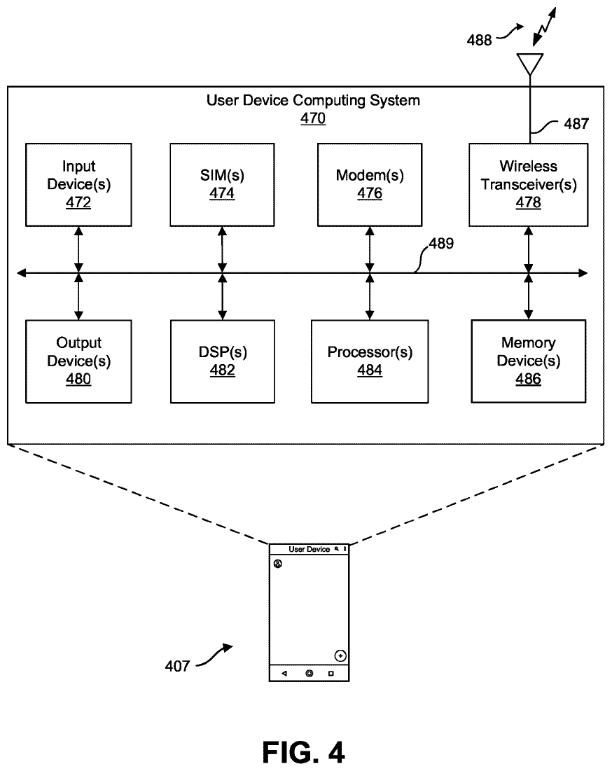

FIG. 4 illustrates an example of a computing system 470 of a wireless device 407. The wireless device 407 may include a client device such as a UE (e.g., UE 104, UE 152, UE 190) or other type of device (e.g., a station (STA) configured to communication using a Wi-Fi interface) that may be used by an end-user. For example, the wireless device 407 may include a mobile phone, router, tablet computer, laptop computer, tracking device, wearable device (e.g., a smart watch, glasses, an extended reality (XR) device such as a virtual reality (VR), augmented reality (AR) or mixed reality (MR) device, etc.), Internet of Things (IoT) device, access point, and/or another device that is configured to communicate over a wireless communications network. The computing system 470 includes software and hardware components that may be electrically or communicatively coupled via a bus 489 (or may otherwise be in communication, as appropriate). For example, the computing system 470 includes one or more processors 484. The one or more processors 484 may include one or more CPUs, ASICs, FPGAs, APs, GPUs, VPUs, NSPs, microcontrollers, dedicated hardware, any combination thereof, and/or other processing device or system. The bus 489 may be used by the one or more processors 484 to communicate between cores and/or with the one or more memory devices 486.

The computing system 470 may also include one or more memory devices 486, one or more digital signal processors (DSPs) 482, one or more subscriber identity modules (SIMs) 474, one or more modems 476, one or more wireless transceivers 478, one or more antennas 487, one or more input devices 472 (e.g., a camera, a mouse, a keyboard, a touch sensitive screen, a touch pad, a keypad, a microphone, and/or the like), and one or more output devices 480 (e.g., a display, a speaker, a printer, and/or the like).

In some aspects, computing system 470 may include one or more radio frequency (RF) interfaces configured to transmit and/or receive RF signals. In some examples, an RF interface may include components such as modem(s) 476, wireless transceiver(s) 478, and/or antennas 487. The one or more wireless transceivers 478 may transmit and receive wireless signals (e.g., signal 488) via antenna 487 from one or more other devices, such as other wireless devices, network devices (e.g., base stations such as eNBs and/or gNBs, Wi-Fi access points (APs) such as routers, range extenders or the like, etc.), cloud networks, and/or the like. In some examples, the computing system 470 may include multiple antennas or an antenna array that may facilitate simultaneous transmit and receive functionality. Antenna 487 may be an omnidirectional antenna such that radio frequency (RF) signals may be received from and transmitted in all directions. The wireless signal 488 may be transmitted via a wireless network. The wireless network may be any wireless network, such as a cellular or telecommunications network (e.g., 3G, 4G, 5G, etc.), wireless local area network (e.g., a Wi-Fi network), a Bluetooth™ network, and/or other network.

In some examples, the wireless signal 488 may be transmitted directly to other wireless devices using sidelink communications (e.g., using a PC5 interface, using a DSRC interface, etc.). Wireless transceivers 478 may be configured to transmit RF signals for performing sidelink communications via antenna 487 in accordance with one or more transmit power parameters that may be associated with one or more regulation modes. Wireless transceivers 478 may also be configured to receive sidelink communication signals having different signal parameters from other wireless devices.

In some examples, the one or more wireless transceivers 478 may include an RF front end including one or more components, such as an amplifier, a mixer (also referred to as a signal multiplier) for signal down conversion, a frequency synthesizer (also referred to as an oscillator) that provides signals to the mixer, a baseband filter, an analog-to-digital converter (ADC), one or more power amplifiers, among other components. The RF front-end may generally handle selection and conversion of the wireless signals 488 into a baseband or intermediate frequency and may convert the RF signals to the digital domain.

In some cases, the computing system 470 may include a coding-decoding device (or CODEC) configured to encode and/or decode data transmitted and/or received using the one or more wireless transceivers 478. In some cases, the computing system 470 may include an encryption-decryption device or component configured to encrypt and/or decrypt data (e.g., according to the AES and/or DES standard) transmitted and/or received by the one or more wireless transceivers 478.

The one or more SIMs 474 may each securely store an international mobile subscriber identity (IMSI) number and related key assigned to the user of the wireless device 407. The IMSI and key may be used to identify and authenticate the subscriber when accessing a network provided by a network service provider or operator associated with the one or more SIMs 474. The one or more modems 476 may modulate one or more signals to encode information for transmission using the one or more wireless transceivers 478. The one or more modems 476 may also demodulate signals received by the one or more wireless transceivers 478 in order to decode the transmitted information. In some examples, the one or more modems 476 may include a Wi-Fi modem, a 4G (or LTE) modem, a 5G (or NR) modem, and/or other types of modems. The one or more modems 476 and the one or more wireless transceivers 478 may be used for communicating data for the one or more SIMs 474.

The computing system 470 may also include (and/or be in communication with) one or more non-transitory machine-readable storage media or storage devices (e.g., one or more memory devices 486), which may include, without limitation, local and/or network accessible storage, a disk drive, a drive array, an optical storage device, a solid-state storage device such as a RAM and/or a ROM, which may be programmable, flash-updateable and/or the like. Such storage devices may be configured to implement any appropriate data storage, including without limitation, various file systems, database structures, and/or the like.

In various embodiments, functions may be stored as one or more computer-program products (e.g., instructions or code) in memory device(s) 486 and executed by the one or more processor(s) 484 and/or the one or more DSPs 482. The computing system 470 may also include software elements (e.g., located within the one or more memory devices 486), including, for example, an operating system, device drivers, executable libraries, and/or other code, such as one or more application programs, which may comprise computer programs implementing the functions provided by various embodiments, and/or may be designed to implement methods and/or configure systems, as described herein.

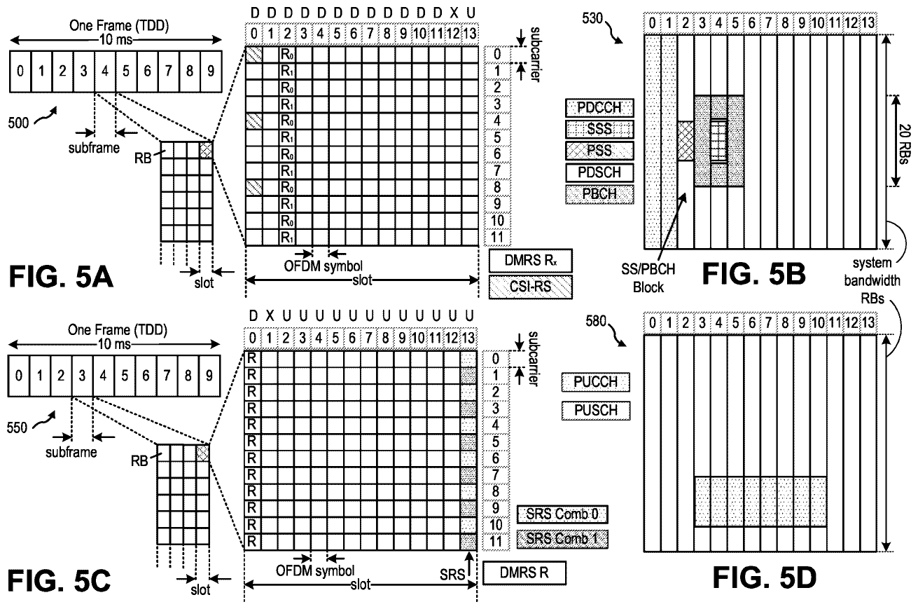

FIGS. 5A-5D depict various example aspects of data structures for a wireless communication system, such as wireless communication system 100 of FIG. 1. FIGS. 5A-5D depict aspects of data structures for a wireless communication network, such as wireless communication network 100 of FIG. 1. In particular, FIG. 5A is a diagram 500 illustrating an example of a first subframe within a 5G (e.g., 5G NR) frame structure, FIG. 5B is a diagram 530 illustrating an example of DL channels within a 5G subframe, FIG. 5C is a diagram 550 illustrating an example of a second subframe within a 5G frame structure, and FIG. 5D is a diagram 580 illustrating an example of UL channels within a 5G subframe.

In various aspects, the 5G frame structure may be frequency division duplex (FDD), in which for a particular set of subcarriers (carrier system bandwidth), subframes within the set of subcarriers are dedicated for either DL or UL. 5G frame structures may also be time division duplex (TDD), in which for a particular set of subcarriers (carrier system bandwidth), subframes within the set of subcarriers are dedicated for both DL and UL. In the examples provided by FIGS. 5A and 5C, the 5G frame structure is assumed to be TDD, with subframe 4 being configured with slot format 28 (with mostly DL), where D is DL, U is UL, and X is flexible for use between DL/UL, and subframe 3 being configured with slot format 34 (with mostly UL). While subframes 3, 4 are shown with slot formats 34, 28, respectively, any particular subframe may be configured with any of the various available slot formats 0-61. Slot formats 0, 1 are all DL, UL, respectively. Other slot formats 2-61 include a mix of DL, UL, and flexible symbols. UEs are configured with the slot format (dynamically through DL control information (DCI), or semi-statically/statically through radio resource control (RRC) signaling) through a received slot format indicator (SFI). Note that the description below applies also to a 5G frame structure that is TDD.

Other wireless communication technologies may have a different frame structure and/or different channels. A frame (10 ms) may be divided into 10 equally sized subframes (1 ms). Each subframe may include one or more time slots. Subframes may also include mini-slots, which may include 7, 4, or 2 symbols. In some examples, each slot may include 7 or 14 symbols, depending on the slot configuration.

For example, for slot configuration 0, each slot may include 14 symbols, and for slot configuration 1, each slot may include 7 symbols. The symbols on DL may be cyclic prefix (CP) OFDM (CP-OFDM) symbols. The symbols on UL may be CP-OFDM symbols (for high throughput scenarios) or discrete Fourier transform (DFT) spread OFDM (DFT-s-OFDM) symbols (also referred to as single carrier frequency-division multiple access (SC-FDMA) symbols) (for power limited scenarios; limited to a single stream transmission).

The number of slots within a subframe is based on the slot configuration and the numerology. For slot configuration 0, different numerologies (μ) 0 to 5 allow for 1, 2, 4, 8, 16, and 32 slots, respectively, per subframe. For slot configuration 1, different numerologies 0 to 2 allow for 2, 4, and 8 slots, respectively, per subframe. Accordingly, for slot configuration 0 and numerology μ, there are 14 symbols/slot and 2 μ slots/subframe. The subcarrier spacing and symbol length/duration are a function of the numerology. The subcarrier spacing may be equal to 2^{μ}×15 kHz, where μ is the numerology 0 to 5. As such, the numerology μ=0 has a subcarrier spacing of 15 kHz and the numerology μ=5 has a subcarrier spacing of 480 kHz. The symbol length/duration is inversely related to the subcarrier spacing. FIGS. 5A-5D provide an example of slot configuration 0 with 14 symbols per slot and numerology μ=2 with 4 slots per subframe. The slot duration is 0.25 ms, the subcarrier spacing is 60 kHz, and the symbol duration is approximately 16.67 μs.

A resource grid may be used to represent the frame structure. Each time slot includes a resource block (RB) (also referred to as physical RBs (PRBs)) that extends 12 consecutive subcarriers. The resource grid is divided into multiple resource elements (REs). The number of bits carried by each RE depends on the modulation scheme.

As illustrated in FIG. 5A, some of the REs carry reference (pilot) signals (RS) for a UE (e.g., UE 104, UE 152, UE 190). The RS may include demodulation RS (DM-RS) (indicated as Rx for one particular configuration, where 100x is the port number, but other DM-RS configurations are possible) and channel state information reference signals (CSI-RS) for channel estimation at the UE. The RS may also include beam measurement RS (BRS), beam refinement RS (BRRS), and phase tracking RS (PT-RS).

FIG. 5B illustrates an example of various DL channels within a subframe of a frame. The physical downlink control channel (PDCCH) carries DCI within one or more control channel elements (CCEs), each CCE including nine RE groups (REGs), each REG including four consecutive REs in an OFDM symbol.

A primary synchronization signal (PSS) may be within symbol 2 of particular subframes of a frame. The PSS is used by a UE (e.g., UE 104, UE 152, UE 190) to determine subframe/symbol timing and a physical layer identity.

A secondary synchronization signal (SSS) may be within symbol 4 of particular subframes of a frame. The SSS is used by a UE to determine a physical layer cell identity group number and radio frame timing.

Based on the physical layer identity and the physical layer cell identity group number, the UE can determine a physical cell identifier (PCI). Based on the PCI, the UE can determine the locations of the aforementioned DM-RS. The physical broadcast channel (PBCH), which carries a master information block (MIB), may be logically grouped with the PSS and SSS to form a synchronization signal (SS)/PBCH block. The MIB provides a number of RBs in the system bandwidth and a system frame number (SFN). The physical downlink shared channel (PDSCH) carries user data, broadcast system information not transmitted through the PBCH such as system information blocks (SIBs), and paging messages.

As illustrated in FIG. 5C, some of the REs carry DM-RS (indicated as R for one particular configuration, but other DM-RS configurations are possible) for channel estimation at the base station. The UE may transmit DM-RS for the physical uplink control channel (PUCCH) and DM-RS for the physical uplink shared channel (PUSCH). The PUSCH DM-RS may be transmitted in the first one or two symbols of the PUSCH. The PUCCH DM-RS may be transmitted in different configurations depending on whether short or long PUCCHs are transmitted and depending on the particular PUCCH format used. The UE may transmit sounding reference signals (SRS). The SRS may be transmitted in the last symbol of a subframe. The SRS may have a comb structure, and a UE may transmit SRS on one of the combs. The SRS may be used by a base station for channel quality estimation to enable frequency-dependent scheduling on the UL.

FIG. 5D illustrates an example of various UL channels within a subframe of a frame. The PUCCH may be located as indicated in one configuration. The PUCCH carries uplink control information (UCI), such as scheduling requests, a channel quality indicator (CQI), a precoding matrix indicator (PMI), a rank indicator (RI), and HARQ ACK/NACK feedback. The PUSCH carries data, and may additionally be used to carry a buffer status report (BSR), a power headroom report (PHR), and/or UCI.

Generally, different service providers operate different wireless networks. In some cases, a single service provider may also operate multiple wireless networks where the wireless networks use different radio access technologies (RATs), such as LTE, 5G NR, Wi-Fi, etc. In some cases, a wireless device that is not connected to one or more wireless networks may be in an idle mode. In an idle state, the wireless device is not registered (e.g., authenticated/associated) with one or more wireless networks of a service provider (e.g., wireless network operator). Examples of idle mode include when a device is in an RRC_Idle state with respect to a wireless network, when a device is not authenticated and/or associated with an AP, etc. In cases where a wireless device is capable of maintaining multiple wireless connections to multiple wireless networks, the wireless device may be in idle mode with respect to a first wireless network and be in another state, such as a connected state, with respect to a second wireless network. For example, a wireless device with dual subscriber identity modules (SIMs) may be connected to (e.g., in a connected mode such as RRC_Connected) a first wireless network via a first SIM and in idle mode with respect to the second SIM. Similarly, another wireless device can be connected to a cellular wireless network while in an idle state with respect to Wi-Fi networks. In some cases, a wireless device in idle mode (e.g., idle state) may monitor a wireless medium for broadcast and paging messages (e.g., on the PBCH for the PSS/SSS, etc., and the PDSCH) from wireless networks. Generally, the wireless device in idle mode can only transmit a limited set of messages, such as a connection message to establish a connection, to a wireless network that the wireless device is not already connected to.

In idle mode, the wireless device may be able to make limited measurements of signals received from the wireless networks, but the wireless device may not be able to exchange messages with the wireless networks to help perform more detailed signal measurements. In some cases, these measurements are physical (PHY) layer measurements that are performed without accessing higher layer operations. For example, the wireless device PHY layer may be able to make a reference signal received power (RSRP), received signal strength indication (RSSI), signal-to-noise (SNR), doppler spread, delay spread, etc. measurements of a beacon or other reference signal, but may not make measurements which require feedback to/from or other cooperation with the wireless network.

In many cases, a wireless device can accurately project a throughput available while connected to the wireless network through a particular access cell via channel status information (CSI) such as CQI feedback, DCI information, etc. However, this CSI information is generally only available while in connected mode where the wireless network is aware of and signaling to the wireless device. A wireless device in idle mode is typically limited to measurements of reference signals from wireless networks, such as a synchronization signal block (SSB) broadcast, while in idle mode, and the wireless device may not be able to accurately evaluate a possible throughput of a wireless network. While a wireless device may be able to measure a RSSP/RSSI/SNR of a reference signal sent by a wireless network, a measurement of how strong a received signal is does not necessarily reflect the throughput possible on the wireless network. For example, a wireless network with a 20 MHz channel width and a strong signal (e.g., as measured by RSSP/RSSI/SNR) may still deliver less throughput than another wireless network with an 80 MHz channel width and a relatively weaker signal (e.g., as measured by RSSP/RSSI/SNR). Additionally, without establishing a connection to a wireless network through a cell, the wireless device may not be able to determine how the wireless connection (e.g., the cell) is configured (e.g., available channel width, number of component carriers, QAM configuration, etc.). This possible throughput information may be useful to the wireless device when deciding, for example, whether to switch and/or connect to another wireless network. In accordance with aspects of the present disclosure, a technique for idle mode throughput estimation may be provided which uses PHY layer measurements to help estimate an amount of throughput that may be available from various wireless networks.

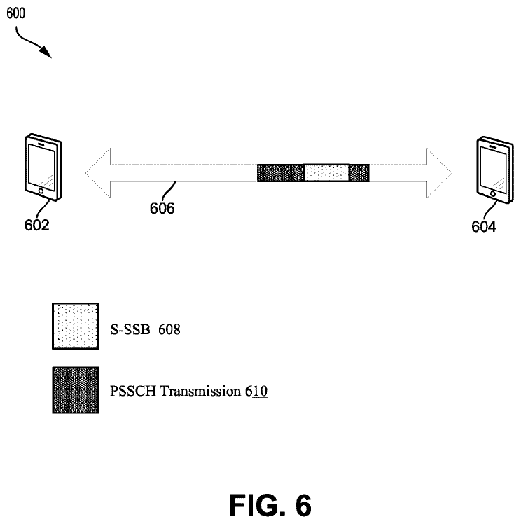

FIG. 6 illustrates an example of a wireless communications system 600 that supports S-SSB designs for shared spectrum, in accordance with aspects of the present disclosure. In some cases, the wireless communications system 600 may implement aspects of the wireless communications system 100. For example, the wireless communications system 600 may include UE 602 and UE 604 communicating via a sidelink connection 606, which may correspond to UEs 190 and 104 and link 192 as described with reference to FIG. 1. The wireless communications system 600 may support the use of an S-SSB waveform that may be multiplexed with combined physical sidelink control channel (PSCCH) and physical sidelink shared channel (PSSCH) (PSCCH/PSSCH) signal in a same subchannel (e.g., a 20 MHz subchannel) in a slot, and the S-SSB waveform may avoid impact on PSCCH decoding while also avoiding resources configured for DMRS and SCI (e.g., SCI-2). In some cases, the S-SSB and the PSCCH resources may be included in a single subchannel, such as a 20 MHz subchannel.

Wireless communications system 600 may be an example of a 5G NR system, and may support wireless devices establishing an access link (e.g., a Uu interface) and/or a sidelink (e.g., a PC5 interface). For example, UE 602 may establish an access link with a network entity (not shown) and a sidelink (e.g., a sidelink communication link) with another UE 604. In some cases, a UE 602 may establish an access link with a network entity (not shown) and may establish a sidelink connection 606 with another UE 604 which operates as a relay (e.g., which has an access link with the same or different network entity) such that the UE 602 may communicate with a network via either the access link, or the sidelink, or both. In some cases, the sidelink connection 606 may be used extend a coverage area. For example, a UE 602 may establish a sidelink with another UE 604 (e.g., a relay UE) having an access link with a network entity (not shown) for which the UE 602 is out of coverage. Sidelink communications may be referred to as vehicle-to-vehicle (V2V) communications, vehicle-to-everything (V2X) communications, D2D communications, or other terminology.

The wireless communications system 600 may include a sidelink connection 606 (e.g., a D2D P2P link 192 as described with reference to FIG. 1). The UE 602 may transmit information to the UE 604, and the UE 604 may similarly transmit information to the UE 602, over the sidelink connection 606. As an example, the UE 602 may transmit a PSSCH transmission 610 to the UE 604. In some cases, the UE 602 may transmit using time-frequency resources, which may not be synchronous with the operation of the UE 604. For example, the UE 602 may transmit a PSSCH transmission 610 using a first slot, and the UE 604 may be unaware of the slot boundary to be used for receiving the PSSCH transmission 610. As such, the UE 602 may transmit (e.g., periodically) one or more S-SSBs 608, which may facilitate synchronization of communications between multiple UEs. The UE 604 may receive the S-SSB 608 and perform one or more operations to synchronize time-frequency resources with the UE 602. In some cases, the S-SSB 608 may include a PSS and an SSS. A UE, such as UE 602 and/or UE 604, may transmit the S-SSB 608 using multicast, groupcast, or broadcast signaling. Additionally, the S-SSBs 608 may be used by additional UEs to discover the UE (e.g., UE 602) transmitting the S-SSB 608.

The wireless communications system 600 may support sidelink communications in shared radio frequency spectrum bands (e.g., unlicensed radio frequency spectrum bands), which may not be reserved, allocated, or licensed for specific use cases or specific RATs. For example, the UE 602 may transmit the PSSCH transmission 610 to the UE 604 using one or more unlicensed radio frequency bands. The UE 602 may perform one or more channel access procedures to gain access to the one or more unlicensed frequency bands. As an example, UE 602 may communicate using time-frequency resources after gaining access to a channel using one or more channel access techniques (e.g., listen before talk (LBT)) to reserve resources for transmitting a signal. Upon gaining access to the shared spectrum, the UE 602 may transmit signaling using a number of symbol periods (e.g., OFDM symbol periods) within a slot, which may be an example of a transmission time interval (TTI).

The shared spectrum may be associated with one or more conditions for spectrum usage. In some cases, a condition for shared spectrum usage may be associated with an OCB. An OCB may be defined as a bandwidth that contains a portion (e.g., 99%) of a total signal power. For example, UE 602 may transmit a signal with a nominal bandwidth. However, the signal (e.g., the measured signal) may occupy a portion of the nominal bandwidth (e.g., due to variations in signal power). In some cases, the OCB may be smaller than the nominal bandwidth.

A condition for shared spectrum usage may include a threshold associated with an OCB. For example, a wireless communication standard may specify a threshold percentage of a total signal power for a respective channel, which may be referred to herein as a “threshold OCB” or an “OCB threshold.” In some other cases, a wireless communication standard may specify a threshold percentage of a total signal power, a threshold bandwidth, or both. The wireless communications system 300 may support one or more OCB thresholds for shared spectrum communications to reduce a percentage of a signal's bandwidth that is outside of a bandwidth allocated for communications between UEs (e.g., to reduce interference and enable fairness to other transmitting devices in the system). An OCB threshold may be expressed as a minimum percentage of a nominal channel bandwidth to be occupied. For example, a wireless communications standard may specify that an OCB is larger than 80% of a respective nominal channel bandwidth.

In some cases, transmission may be multiplexed to increase an OCB. For example, for non-sidelink transmissions, an SSB may be multiplexed in the downlink with one or more other transmissions, such as channel state information reference signal (CSI-RS) transmissions, remaining minimum system information (RMSI) transmissions, physical downlink control channel (PDCCH) transmissions, physical downlink shared channel (PDSCH) transmission, and other transmission types (e.g., non-unicast transmissions). In some cases, however, a UE, such as UE 602 and/or UE 604, may be unable to meet a minimum OCB threshold, such as for some transmissions of an S-SSB. For example, the UE 602 may be unable to transmit S-SSB to the UE 604 while satisfying the OCB threshold.

In some cases, the UE 602 may use some techniques for transmitting S-SSBs in accordance with a configuration of the S-SSB such that the S-SSB occupies a full slot and. Here, the UE 602 may be unable to multiplex the S-SSB with other transmissions because the S-SSB structure (e.g., waveform) may not match a resource pool structure associated with other transmission types (e.g., a resource pool structure for PSCCH and PSSCH transmissions). Further, the S-SSB may be incompatible with one or more resource configurations (e.g., a sub-channel-based resource pool configuration). For instance, a resource pool for the S-SSB may not overlap with a resource pool for other transmissions. Accordingly, the UE 602 may be unable to transmit the S-SSB while satisfying an OCB threshold. As an illustrative example, the UE 602 may transmit an S-SSB using a slot (e.g., 14 symbols including a gap symbol), where the S-SSB may occupy 11 resource blocks RBs of a BWP. The slot used for the S-SSB, however, may not be used for other message types, such as PSSCH transmissions 610. An OCB threshold may not be satisfied when no other signals are transmitted in the slot along with the S-SSBs, and some S-SSB transmissions may thus not occupy more than 80% of a respective nominal channel bandwidth.

In accordance with the techniques described herein, a UE 602 may transmit one or more S-SSBs 608, which may be multiplexed with PSCCH/PSSCH in a same subchannel (20 MHZ subchannel) in a TTI (e.g., a slot). For example, the UE 602 may transmit one or more S-SSBs 608 using a portion of a slot and avoiding use of time-frequency resources for other transmission types, such as PSCCH transmissions, automatic gain (AGC) control symbols, DMRS transmissions, and other transmission types for those S-SSB 608 portion of the slot. For example, the PSCCH/PSSCH may include an AGC in a first symbol of the PSCCH/PSSCH portion of the slot and the S-SSB 608 portion of the slot would not need a separate AGC symbol. The UE 602 may transmit an S-SSB 608 using a number of symbol periods that follow a first number symbol periods of the slot. Put another way, the symbol periods for the S-SSB transmission may be different from an initial symbols of the slot. In some cases, the UE 602 my transmit the one or more S-SSBs using a waveform configuration, which may enable the UE 602 to multiplex (e.g., FDM or TDM) the S-SSB with other transmissions (e.g., PSSCH transmissions). Accordingly, the UE 602 may configure one or more waveform parameters for the S-SSB to increase an OCB and satisfy an OCB threshold.

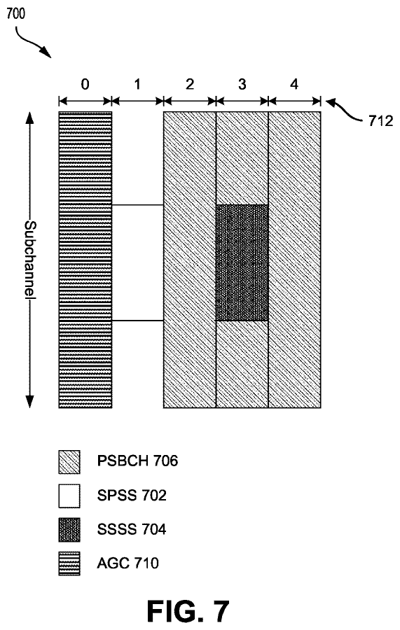

FIG. 7 illustrates an example S-SSB 700, in accordance with aspects of the present disclosure. In some cases, the S-SSB 700 may be multiplexed along with data, such as the same sub-channel as the PSCCH/PSSCH. In other cases, the S-SSB 700 may be broadcast as a stand-alone transmission. In some cases, multiple copies S-SSB 700 may be broadcast in one slot, for example, if one S-SSB 700 is insufficient to fill a slot. The S-SSB 700 may be implemented, for example, by a wireless communication system, such as wireless communications system 600 and/or wireless communications system 100.

Multiple signals may make up the S-SSB 700. For example, the S-SSB may include a sidelink primary synchronization signal (SPSS) 702, a sidelink secondary synchronization signal (SSSS) 704 and/or a physical sidelink broadcast channel (PSBCH) 706. In some cases, the S-SSB 700 may occupy a single subchannel. As shown in in the example of FIG. 7, the S-SSB 700 occupies a single 20 RB subchannel. The SPSS 702 may enable synchronization of slot timing and may indicate a physical layer identifier associated with a first sidelink UE transmitting the S-SSB 700. The SSSS 704 may enable radio frame synchronization. The SSSS 704 may also enable detection of a duplexing mode and a cyclic prefix length. In some cases, the first sidelink UE may transmit S-SSB 700 using multiple beams in a beam-sweeping manner. In some examples, the S-SSB 700 may be transmitted on respective directional beams, where one or more SSBs may be included within a burst.

In some cases, an AGC symbol 710 may be located in a leading symbol of the S-SSB 700 when the S-SSB 700 is transmitted as a stand-alone transmission (e.g., not multiplexed with a PSCCH/PSSCH). The leading symbol of the S-SSB 700 may be the first symbol of the S-SSB 700 to be transmitted. The AGC symbol 710 may be received by a second sidelink UE and used to set an amplifier gain of a receiver (such as transceiver 478 of FIG. 4) of the second sidelink UE. Setting the gain of the receiver of the second sidelink UE using the AGC symbol 710 in the leading symbol of the S-SSB 700 may enable the second sidelink UE to properly decode the SPSS 702, SSSS 704, and/or PSBCH 706 received in subsequent symbols. In some examples, the content of the AGC symbol 710 may match the content of a PSBCH 706 symbol of the S-SSB 700. Thus, the leading symbol of the S-SSB 700 serving as an AGC symbol 710 for the second sidelink UE may be the same as one of the PSBCH 706 symbols of the S-SSB 700. The AGC symbol 710 may match any one of the PSBCH 706 symbols of the S-SSB 700.

In some aspects, the first sidelink UE may perform one or more rate matching operations associated with the S-SSB 700. For example, the first sidelink UE may rate match the PSBCH 706 resources around the AGC symbol 710 resources. In some cases, the first sidelink UE may rate match the PSBCH 706 resources around the AGC symbol 710 resources in order to satisfy an occupied channel bandwidth (OCB) threshold (e.g., an 80% OCB threshold).

As shown in FIG. 7, example S-SSB 700 may be five symbols 712 long. In some cases, such as for V2X use cases, an S-SSB may have two SPSS 702 and/or two SSSS 704 symbols. To help accommodate such cases, the S-SSB 700 may be enhanced to accommodate multiple SPSS 702 and/or multiple SSSS 704 symbols.

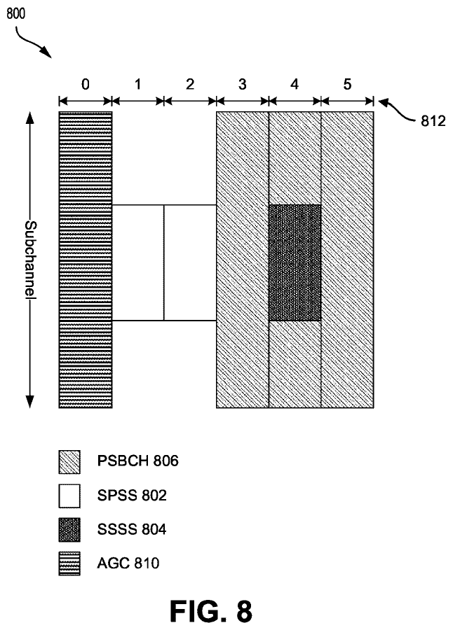

FIG. 8 illustrates an example enhanced S-SSB 800 with multiple SPSS symbols 802, in accordance with aspects of the present disclosure. The enhanced S-SSB 800 may be implemented, for example, by a wireless communication system, such as wireless communications system 600 and/or wireless communications system 100. As shown in FIG. 8, enhanced S-SSB 800 may include a PSBCH 806, SSSS 804, AGC 810, and SPSS 802 symbols. As with S-SSB 700, the SSS 804 may be multiplexed with the PSBCH 806. In some cases, enhanced S-SSB 800 may include two SPSS 802 symbols after the AGC 810 symbol. To allow for the two SPSS 802 symbols, the enhanced S-SSB 800 may be extended to be six symbols 812 long. The second SPSS 802 symbol provides an additional SPSS 802 symbol which can enhance timing and frequency acquisition of a first UE (e.g., UE transmitting the enhanced S-SSB 800) by a second UE. The second SPSS 802 symbol may be especially helpful for the second UE to receive the SPSS 802 when the second UE is further away from the first UE. Acquisition of the SPSS 802 helps provide coarse timing and frequency information which can make detection of the SSSS 804 substantially easier. In some cases, the two SPSS 802 symbols may not be FDM'd together. That is, the first SPSS 802 symbol may not be FDM's with the additional SPSS 802 symbol and the first SPSS 802 symbol is separate, in the time domain from the additional SPSS 802 symbol. Separating the SPSS 802 symbols in the time domain may help allow for lower cost implementations by helping to avoid, for example, listening for the PSS on a larger bandwidth.

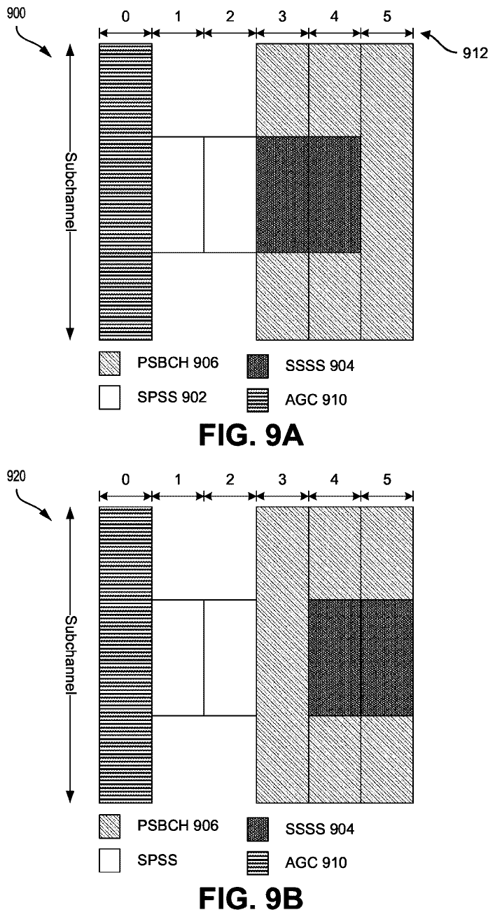

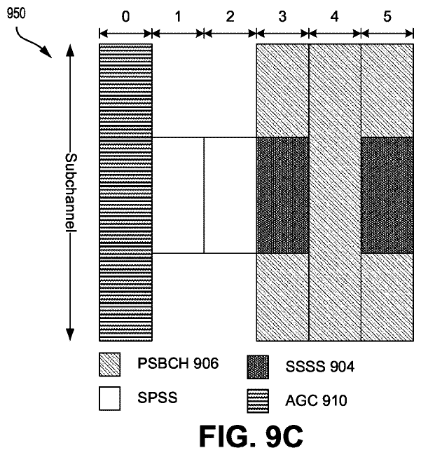

FIGS. 9A-9C illustrates examples of enhanced S-SSBs with multiple SPSS symbols and multiple SSSS symbols, in accordance with aspects of the present disclosure. Any of the S-SSBs illustrated in FIGS. 9A-9C may be implemented, for example, by a wireless communication system, such as wireless communications system 600 and/or wireless communications system 100. Referring to FIG. 9A, an enhanced S-SSB 900 may be six symbols 912 long and include PSBCH 906, SSSS 904, AGC 910, and SPSS 902 symbols. As shown in FIG. 9A, the enhanced S-SSB 900 may include two SPSS 902 symbols and two SSSS 904 symbols. The two SPSS 90902 symbols may be multiplexed with the PSBCH 906. The two SPSS 902 symbols may be multiplexed with any of the PSBCH 906 symbols. For example, in FIG. 9A, the SPSS 902 symbols are multiplexed in the PSBCH 906 symbols in symbols 3 and 4 of enhanced S-SSB 900. Similarly, the SPSS 902 symbols may be multiplexed in PSBCH 906 symbols in symbols 4 and 5 of enhanced S-SSB 920, as shown in FIG. 9B, or the SPSS 902 symbols may be multiplexed in PSBCH 906 symbols in symbols 3 and 5 of enhanced S-SSB 950, as shown in FIG. 9C.

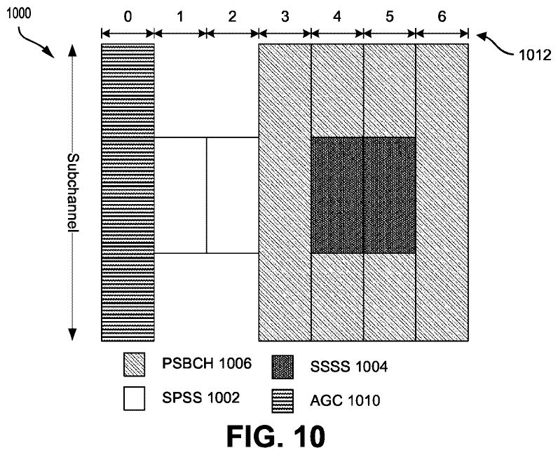

FIG. 10 illustrates an example enhanced S-SSB 1000 multiple SPSS symbols, multiple SSSS symbols, and expanded PSBCH, in accordance with aspects of the present disclosure. The enhanced S-SSB 1000 may be implemented, for example, by a wireless communication system, such as wireless communications system 600 and/or wireless communications system 100. In some cases, having two SPSS symbols multiplexed with the PSBCH symbols may reduce an amount of PSBCH resource elements (REs) available. To avoid impacting PSBCH performance, a number of PSBCH symbol may be expanded and a total number of symbols 1012 of the enhanced S-SSB 1000 may be seven symbols. As shown in FIG. 10, the enhanced S-SSB 1000 may include an AGC 1010 symbol, two SPSS 1002 symbols, four PSBCH 1006 symbols, and two SSSS 1004 symbols, which can be multiplexed into any of the four PSBCH 1006 symbols.

As indicated above, the enhanced S-SSB's may be multiplexed with PSCCH/PSSCH in a same subchannel in a slot. In some cases, a S-SSB which is six or seven symbols long may limit the PSCCH/PSSCH symbols which may be multiplexed. In addition, DMRS symbols may be included with the PSCCH/PSSCH, for example for channel estimation and Doppler compensation by a receiver. In some cases, where a six symbol S-SSB is multiplexed with the PSCCH/PSSCH, a number of DMRS symbols may be limited to two symbols, a number of PSCCH symbols may be limited to two symbols, and a length of the PSSCH symbol (e.g., a number of symbols making up the PSSCH resource) may be greater than ten. In some cases, the DMRS may occupy symbol number 3 and number 10 of the PSCCH/PSSCH to provide enough of a gap for multiplexing the six symbol S-SSB. In some cases, if an S-SSB is included in the resource pool, multiplexing the seven symbol S-SSB may not be preferred to avoid frequency domain rate match handling of the DMRS around the seven symbol S-SSB.

As indicated above, when an S-SSB (e.g., any of the 5, 6, or 7 symbol S-SSBs discussed above) is transmitted as a stand-alone transmission (e.g., not multiplexed with a PSCCH/PSSCH), the S-SSB may include an AGC symbol as a leading symbol of the S-SSB. In some cases, where the S-SSB is multiplexed with a PSCCH/PSSCH, the S-SSB may not include the AGC symbol.

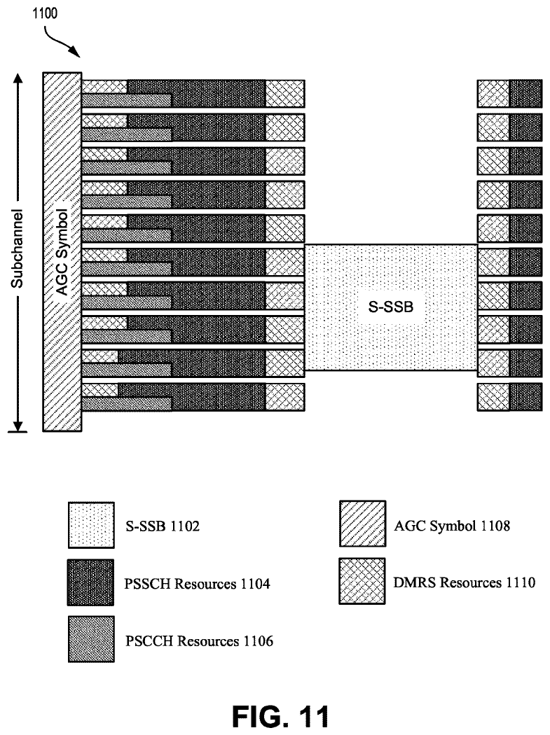

FIG. 11 illustrates an example of an S-SSB multiplexed with a PSCCH/PSSCH 1100, in accordance with aspects of the present disclosure. The S-SSB multiplexed with a PSCCH/PSSCH 1100 may be implemented, for example, by a wireless communication system, such as wireless communications system 600 and/or wireless communications system 100. In some cases, the PSCCH/PSSCH 1100 may include time/frequency resources for one or more transmission types. For example, the PSCCH/PSSCH 1100 may include time/frequency resources for an S-SSB 1102. The PSCCH/PSSCH 1100 may also include time/frequency resources for PSSCH resources 1104, PSCCH resources 1106, AGC symbol 1108, DMRS resources 1110, or any combination thereof. In some cases, the AGC symbol 1108 may be included as the leading symbol of the PSCCH/PSSCH 1100 and the S-SSB 1102 may not include a separate AGC symbol. In some cases, the S-SSB 1102 may be similar to any of S-SSBs 700, 800, 900, 920, 950, or 1000, except without the AGC symbols 710, 810, 910, or 1010, respectively. Where the S-SSB 1102 does not include a separate AGC symbol, a receiving UE may use the AGC symbol 1108 of the PSCCH/PSSCH 1100 to perform training for detecting S-SSB 1102.

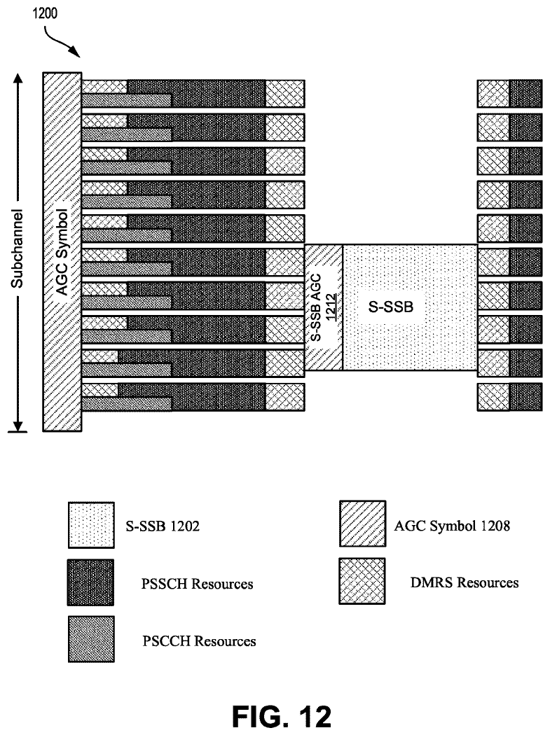

FIG. 12 illustrates an example of an S-SSB having a separate S-SSB AGC symbol 1212 multiplexed with a PSCCH/PSSCH 1200, in accordance with aspects of the present disclosure. In some cases, an AGC symbol 1208 for the PSCCH/PSSCH 1200 is not a good candidate for AGC training to detect a S-SSB 1202. For example, the S-SSB 1202 may be a narrowband (e.g., less than 20 MHz) signal, while the PSCCH/PSSCH 1200 and associated AGC symbol 1208 may be a wideband (e.g., greater than 20 MHz) signal. A narrowband receiver may have difficulties using the wideband AGC for training to detect the S-SSB 1202. In some cases, an S-SSB AGC symbol 1212 may be included with the S-SSB 1202 multiplexed with a PSCCH/PSSCH 1200. The S-SSB AGC symbol 1212 may be specific to the S-SSB 1202 and may be included in a first symbol (e.g., leading symbol) of the S-SSB 1202. This separate S-SSB AGC symbol 1212 may help a receiver searching for the S-SSB 1202 better set the AGC for detecting the S-SSB 1202. The separate S-SSB AGC symbol 1212 may also allow a power variation as between the S-SSB 1202 and the rest of the PSCCH/PSSCH 1200.

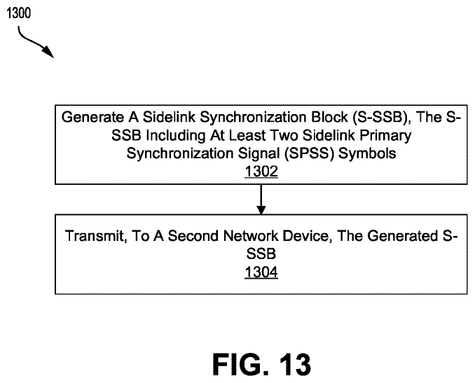

FIG. 13 is a flow diagram illustrating an example of a process for wireless communications 1300, in accordance with aspects of the present disclosure. The process 1300 may be performed by a computing device (or apparatus) or a component (e.g., a chipset, codec, etc.) of the computing device. The computing device may be a mobile device (e.g., a mobile phone), a network-connected wearable such as a watch, an extended reality (XR) device such as a virtual reality (VR) device or augmented reality (AR) device, a vehicle or component or system of a vehicle, or other type of computing device. In some cases, the computing device may be or may include UE device, such as the UE 104 or UE 190 of FIG. 1. The operations of the process 1300 may be implemented as software components that are executed and run on one or more processors.

At block 1302, the computing device (or component thereof) may generate a sidelink synchronization block (S-SSB), the S-SSB including at least two sidelink primary synchronization signal (SPSS) symbols. In some cases, the computing device (or component thereof) may be configured to multiplex the S-SSB with at least one of a physical sidelink control channel (PSCCH) resource or physical sidelink shared channel (PSSCH) resource; and to transmit the generated S-SSB, the at least one processor is further configured to transmit the multiplexed S-SSB with at least one of the PSCCH resource or the PSSCH resource to the second network device. In some cases, a leading symbol of the multiplexed S-SSB comprises an automatic gain control (AGC) symbol. In some cases, the PSCCH resource has a length of two symbols, and wherein the PSSCH resource has a length greater than ten symbols. In some cases, the S-SSB has a length of six symbols. In some cases, the at least one processor is further configured to: multiplex a first sidelink secondary synchronization signal (SSSS) in a physical sidelink broadcast channel (PSBCH) of the S-SSB.

In some cases, the computing device (or component thereof) may be configured to multiplex a second sidelink secondary synchronization signal (SSSS) in the physical sidelink broadcast channel (PSBCH) of the S-SSB, wherein the first SSSS and second SSSS are multiplexed into different symbols of the PSBCH. In some cases, the PSBCH has a length of three symbols. In some cases, the PSBCH has a length of four symbols. In some cases, the S-SSB has a length of seven symbols.

At block 1304, the computing device (or component thereof) may transmit, to a second network device, the generated S-SSB. In some cases, the computing device (or component thereof) may be implemented as a first user equipment (UE), and the computing device (or component thereof) may include at least one transceiver configured to transmit the generated S-SSB. In some cases, the second network device comprises a second UE.

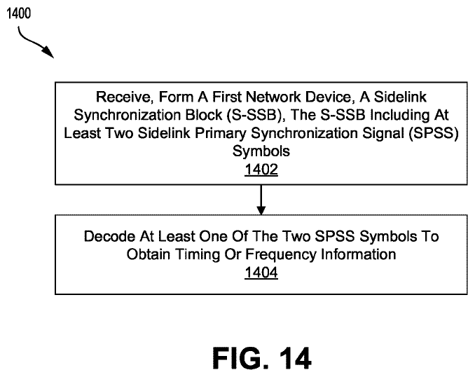

FIG. 14 is a flow diagram illustrating an example of a process for wireless communications 1400, in accordance with aspects of the present disclosure. The process 1400 may be performed by a computing device (or apparatus) or a component (e.g., a chipset, codec, etc.) of the computing device. The computing device may be a mobile device (e.g., a mobile phone), a network-connected wearable such as a watch, an extended reality (XR) device such as a virtual reality (VR) device or augmented reality (AR) device, a vehicle or component or system of a vehicle, or other type of computing device. In some cases, the computing device may be or may include UE device, such as the UE 104 or UE 190 of FIG. 1. The operations of the process 1400 may be implemented as software components that are executed and run on one or more processors.

At block 1402, the computing device (or component thereof) may receive, form a second network device, a sidelink synchronization block (S-SSB), the S-SSB including at least two sidelink primary synchronization signal (SPSS) symbols. In some cases, the computing device (or component thereof) may detect a sidelink secondary synchronization signal (SSSS) based on at least one of the timing information or the frequency information; decode the SSSS to obtain a physical cell identifier of the second network device; and connect to the second network device based on at least one of the timing information or the frequency information and the physical cell identifier. In some cases, the S-SSB is multiplexed with at least one of a physical sidelink control channel (PSCCH) resource or a physical sidelink shared channel (PSSCH) resource. In some cases, the PSCCH resource has a length of two symbols, and wherein the PSSCH resource has a length greater than ten symbols. In some cases, a leading symbol of the S-SSB comprises an automatic gain control (AGC) symbol. In some cases, the S-SSB has a length of six symbols.

In some cases, first sidelink secondary synchronization signal (SSSS) is multiplexed in a physical sidelink broadcast channel (PSBCH) of the S-SSB. In some cases, a second SSSS is multiplexed in the PSBCH, and wherein the first SSSS and second SSSS are multiplexed into different symbols of the PSBCH. In some cases, the PSBCH has a length of four symbols. In some cases, the S-SSB has a length of seven symbols.

At block 1404, the computing device (or component thereof) may decode at least one of the two SPSS symbols to obtain at least one of timing information or frequency information.

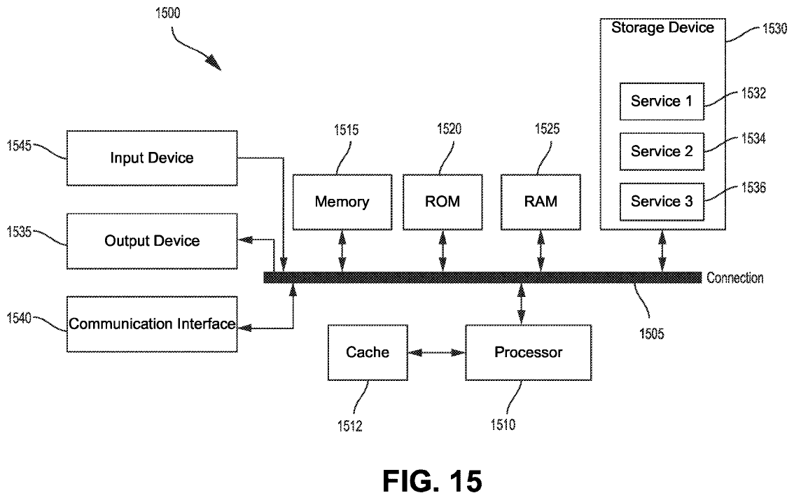

In some examples, the processes described herein (e.g., process 1300, 1400, and/or other process described herein) may be performed by a computing device or apparatus (e.g., a UE or a base station). In another example, the process 1300 and 1400 may be performed by either the UE 104 or UE 190 of FIG. 1. In another example, the process 1300 or 1400 may be performed by a computing device with the computing system 1500 shown in FIG. 15.

FIG. 15 is a diagram illustrating an example of a system for implementing certain aspects of the present technology. In particular, FIG. 15 illustrates an example of computing system 1500, which may be for example any computing device making up internal computing system, a remote computing system, a camera, or any component thereof in which the components of the system are in communication with each other using connection 1505. Connection 1505 may be a physical connection using a bus, or a direct connection into processor 1510, such as in a chipset architecture. Connection 1505 may also be a virtual connection, networked connection, or logical connection.

In some embodiments, computing system 1500 is a distributed system in which the functions described in this disclosure may be distributed within a datacenter, multiple data centers, a peer network, etc. In some embodiments, one or more of the described system components represents many such components each performing some or all of the function for which the component is described. In some embodiments, the components may be physical or virtual devices.

Example system 1500 includes at least one processing unit (CPU or processor) 1510 and connection 1505 that communicatively couples various system components including system memory 1515, such as read-only memory (ROM) 1520 and random access memory (RAM) 1525 to processor 1510. Computing system 1500 may include a cache 1512 of high-speed memory connected directly with, in close proximity to, or integrated as part of processor 1510.

Processor 1510 may include any general purpose processor and a hardware service or software service, such as services 1532, 1534, and 1536 stored in storage device 1530, configured to control processor 1510 as well as a special-purpose processor where software instructions are incorporated into the actual processor design. Processor 1510 may essentially be a completely self-contained computing system, containing multiple cores or processors, a bus, memory controller, cache, etc. A multi-core processor may be symmetric or asymmetric.

To enable user interaction, computing system 1500 includes an input device 1545, which may represent any number of input mechanisms, such as a microphone for speech, a touch-sensitive screen for gesture or graphical input, keyboard, mouse, motion input, speech, etc. Computing system 1500 may also include output device 1535, which may be one or more of a number of output mechanisms. In some instances, multimodal systems may enable a user to provide multiple types of input/output to communicate with computing system 1500.

Computing system 1500 may include communications interface 1540, which may generally govern and manage the user input and system output. The communication interface may perform or facilitate receipt and/or transmission wired or wireless communications using wired and/or wireless transceivers, including those making use of an audio jack/plug, a microphone jack/plug, a universal serial bus (USB) port/plug, an Apple™ Lightning™ port/plug, an Ethernet port/plug, a fiber optic port/plug, a proprietary wired port/plug, 3G, 4G, 5G and/or other cellular data network wireless signal transfer, a Bluetooth™ wireless signal transfer, a Bluetooth™ low energy (BLE) wireless signal transfer, an IBEACON™ wireless signal transfer, a radio-frequency identification (RFID) wireless signal transfer, near-field communications (NFC) wireless signal transfer, dedicated short range communication (DSRC) wireless signal transfer, 802.11 Wi-Fi wireless signal transfer, wireless local area network (WLAN) signal transfer, Visible Light Communication (VLC), Worldwide Interoperability for Microwave Access (WiMAX), Infrared (IR) communication wireless signal transfer, Public Switched Telephone Network (PSTN) signal transfer, Integrated Services Digital Network (ISDN) signal transfer, ad-hoc network signal transfer, radio wave signal transfer, microwave signal transfer, infrared signal transfer, visible light signal transfer, ultraviolet light signal transfer, wireless signal transfer along the electromagnetic spectrum, or some combination thereof. The communications interface 1540 may also include one or more Global Navigation Satellite System (GNSS) receivers or transceivers that are used to determine a location of the computing system 1500 based on receipt of one or more signals from one or more satellites associated with one or more GNSS systems. GNSS systems include, but are not limited to, the US-based Global Positioning System (GPS), the Russia-based Global Navigation Satellite System (GLONASS), the China-based BeiDou Navigation Satellite System (BDS), and the Europe-based Galileo GNSS. There is no restriction on operating on any particular hardware arrangement, and therefore the basic features here may easily be substituted for improved hardware or firmware arrangements as they are developed.

Storage device 1530 may be a non-volatile and/or non-transitory and/or computer-readable memory device and may be a hard disk or other types of computer readable media which may store data that are accessible by a computer, such as magnetic cassettes, flash memory cards, solid state memory devices, digital versatile disks, cartridges, a floppy disk, a flexible disk, a hard disk, magnetic tape, a magnetic strip/stripe, any other magnetic storage medium, flash memory, memristor memory, any other solid-state memory, a compact disc read only memory (CD-ROM) optical disc, a rewritable compact disc (CD) optical disc, digital video disk (DVD) optical disc, a blu-ray disc (BDD) optical disc, a holographic optical disk, another optical medium, a secure digital (SD) card, a micro secure digital (microSD) card, a Memory Stick® card, a smartcard chip, a EMV chip, a subscriber identity module (SIM) card, a mini/micro/nano/pico SIM card, another integrated circuit (IC) chip/card, random access memory (RAM), static RAM (SRAM), dynamic RAM (DRAM), read-only memory (ROM), programmable read-only memory (PROM), erasable programmable read-only memory (EPROM), electrically erasable programmable read-only memory (EEPROM), flash EPROM (FLASHEPROM), cache memory (e.g., Level 1 (L1) cache, Level 2 (L2) cache, Level 3 (L3) cache, Level 4 (L4) cache, Level 5 (L5) cache, or other (L#) cache), resistive random-access memory (RRAM/ReRAM), phase change memory (PCM), spin transfer torque RAM (STT-RAM), another memory chip or cartridge, and/or a combination thereof.

The storage device 1530 may include software services, servers, services, etc., that when the code that defines such software is executed by the processor 1510, it causes the system to perform a function. In some embodiments, a hardware service that performs a particular function may include the software component stored in a computer-readable medium in connection with the necessary hardware components, such as processor 1510, connection 1505, output device 1535, etc., to carry out the function. The term “computer-readable medium” includes, but is not limited to, portable or non-portable storage devices, optical storage devices, and various other mediums capable of storing, containing, or carrying instruction(s) and/or data. A computer-readable medium may include a non-transitory medium in which data may be stored and that does not include carrier waves and/or transitory electronic signals propagating wirelessly or over wired connections. Examples of a non-transitory medium may include, but are not limited to, a magnetic disk or tape, optical storage media such as compact disk (CD) or digital versatile disk (DVD), flash memory, memory or memory devices. A computer-readable medium may have stored thereon code and/or machine-executable instructions that may represent a procedure, a function, a subprogram, a program, a routine, a subroutine, a module, a software package, a class, or any combination of instructions, data structures, or program statements. A code segment may be coupled to another code segment or a hardware circuit by passing and/or receiving information, data, arguments, parameters, or memory contents. Information, arguments, parameters, data, etc. may be passed, forwarded, or transmitted via any suitable means including memory sharing, message passing, token passing, network transmission, or the like.

Specific details are provided in the description above to provide a thorough understanding of the embodiments and examples provided herein, but those skilled in the art will recognize that the application is not limited thereto. Thus, while illustrative embodiments of the application have been described in detail herein, it is to be understood that the inventive concepts may be otherwise variously embodied and employed, and that the appended claims are intended to be construed to include such variations, except as limited by the prior art. Various features and aspects of the above-described application may be used individually or jointly. Further, embodiments may be utilized in any number of environments and applications beyond those described herein without departing from the broader scope of the specification. The specification and drawings are, accordingly, to be regarded as illustrative rather than restrictive. For the purposes of illustration, methods were described in a particular order. It should be appreciated that in alternate embodiments, the methods may be performed in a different order than that described.

For clarity of explanation, in some instances the present technology may be presented as including individual functional blocks comprising devices, device components, steps or routines in a method embodied in software, or combinations of hardware and software. Additional components may be used other than those shown in the figures and/or described herein. For example, circuits, systems, networks, processes, and other components may be shown as components in block diagram form in order not to obscure the embodiments in unnecessary detail. In other instances, well-known circuits, processes, algorithms, structures, and techniques may be shown without unnecessary detail in order to avoid obscuring the embodiments.

Further, those of skill in the art will appreciate that the various illustrative logical blocks, modules, circuits, and algorithm steps described in connection with the aspects disclosed herein may be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present disclosure.

Individual embodiments may be described above as a process or method which is depicted as a flowchart, a flow diagram, a data flow diagram, a structure diagram, or a block diagram. Although a flowchart may describe the operations as a sequential process, many of the operations may be performed in parallel or concurrently. In addition, the order of the operations may be re-arranged. A process is terminated when its operations are completed but could have additional steps not included in a figure. A process may correspond to a method, a function, a procedure, a subroutine, a subprogram, etc. When a process corresponds to a function, its termination may correspond to a return of the function to the calling function or the main function.

Processes and methods according to the above-described examples may be implemented using computer-executable instructions that are stored or otherwise available from computer-readable media. Such instructions may include, for example, instructions and data which cause or otherwise configure a general purpose computer, special purpose computer, or a processing device to perform a certain function or group of functions. Portions of computer resources used may be accessible over a network. The computer executable instructions may be, for example, binaries, intermediate format instructions such as assembly language, firmware, source code. Examples of computer-readable media that may be used to store instructions, information used, and/or information created during methods according to described examples include magnetic or optical disks, flash memory, USB devices provided with non-volatile memory, networked storage devices, and so on.

In some embodiments the computer-readable storage devices, mediums, and memories may include a cable or wireless signal containing a bitstream and the like. However, when mentioned, non-transitory computer-readable storage media expressly exclude media such as energy, carrier signals, electromagnetic waves, and signals per se.

Those of skill in the art will appreciate that information and signals may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof, in some cases depending in part on the particular application, in part on the desired design, in part on the corresponding technology, etc.

The various illustrative logical blocks, modules, and circuits described in connection with the aspects disclosed herein may be implemented or performed using hardware, software, firmware, middleware, microcode, hardware description languages, or any combination thereof, and may take any of a variety of form factors. When implemented in software, firmware, middleware, or microcode, the program code or code segments to perform the necessary tasks (e.g., a computer-program product) may be stored in a computer-readable or machine-readable medium. A processor(s) may perform the necessary tasks. Examples of form factors include laptops, smart phones, mobile phones, tablet devices or other small form factor personal computers, personal digital assistants, rackmount devices, standalone devices, and so on. Functionality described herein also may be embodied in peripherals or add-in cards. Such functionality may also be implemented on a circuit board among different chips or different processes executing in a single device, by way of further example.

The instructions, media for conveying such instructions, computing resources for executing them, and other structures for supporting such computing resources are example means for providing the functions described in the disclosure.

The techniques described herein may also be implemented in electronic hardware, computer software, firmware, or any combination thereof. Such techniques may be implemented in any of a variety of devices such as general purposes computers, wireless communication device handsets, or integrated circuit devices having multiple uses including application in wireless communication device handsets and other devices. Any features described as modules or components may be implemented together in an integrated logic device or separately as discrete but interoperable logic devices. If implemented in software, the techniques may be realized at least in part by a computer-readable data storage medium comprising program code including instructions that, when executed, performs one or more of the methods, algorithms, and/or operations described above. The computer-readable data storage medium may form part of a computer program product, which may include packaging materials. The computer-readable medium may comprise memory or data storage media, such as random access memory (RAM) such as synchronous dynamic random access memory (SDRAM), read-only memory (ROM), non-volatile random access memory (NVRAM), electrically erasable programmable read-only memory (EEPROM), FLASH memory, magnetic or optical data storage media, and the like. The techniques additionally, or alternatively, may be realized at least in part by a computer-readable communication medium that carries or communicates program code in the form of instructions or data structures and that may be accessed, read, and/or executed by a computer, such as propagated signals or waves.

The program code may be executed by a processor, which may include one or more processors, such as one or more digital signal processors (DSPs), general purpose microprocessors, an application specific integrated circuits (ASICs), field programmable logic arrays (FPGAs), or other equivalent integrated or discrete logic circuitry. Such a processor may be configured to perform any of the techniques described in this disclosure. A general-purpose processor may be a microprocessor; but in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration. Accordingly, the term “processor,” as used herein may refer to any of the foregoing structure, any combination of the foregoing structure, or any other structure or apparatus suitable for implementation of the techniques described herein.

One of ordinary skill will appreciate that the less than (“<”) and greater than (“>”) symbols or terminology used herein may be replaced with less than or equal to (“≤”) and greater than or equal to (“≥”) symbols, respectively, without departing from the scope of this description.

Where components are described as being “configured to” perform certain operations, such configuration may be accomplished, for example, by designing electronic circuits or other hardware to perform the operation, by programming programmable electronic circuits (e.g., microprocessors, or other suitable electronic circuits) to perform the operation, or any combination thereof.

The phrase “coupled to” or “communicatively coupled to” refers to any component that is physically connected to another component either directly or indirectly, and/or any component that is in communication with another component (e.g., connected to the other component over a wired or wireless connection, and/or other suitable communication interface) either directly or indirectly.

Claim language or other language reciting “at least one of” a set and/or “one or more” of a set indicates that one member of the set or multiple members of the set (in any combination) satisfy the claim. For example, claim language reciting “at least one of A and B” or “at least one of A or B” means A, B, or A and B. In another example, claim language reciting “at least one of A, B, and C” or “at least one of A, B, or C” means A, B, C, or A and B, or A and C, or B and C, A and B and C, or any duplicate information or data (e.g., A and A, B and B, C and C, A and A and B, and so on), or any other ordering, duplication, or combination of A, B, and C. The language “at least one of” a set and/or “one or more” of a set does not limit the set to the items listed in the set. For example, claim language reciting “at least one of A and B” or “at least one of A or B” may mean A, B, or A and B, and may additionally include items not listed in the set of A and B.

Illustrative aspects of the disclosure include:

Aspect 1. A first network device for wireless communications, comprising: at least one memory comprising instructions; and at least one processor coupled to the memory and configured to: generate a sidelink synchronization block (S-SSB), the S-SSB including at least two sidelink primary synchronization signal (SPSS) symbols; and transmit, to a second network device, the generated S-SSB.

Aspect 2. The first network device of claim 1, wherein: the at least one processor is further configured to multiplex the S-SSB with at least one of a physical sidelink control channel (PSCCH) resource or physical sidelink shared channel (PSSCH) resource; and to transmit the generated S-SSB, the at least one processor is further configured to transmit the multiplexed S-SSB with at least one of the PSCCH resource or the PSSCH resource to the second network device.

Aspect 3. The first network device of claim 2, wherein a leading symbol of the multiplexed S-SSB comprises an automatic gain control (AGC) symbol.

Aspect 4. The first network device of claim 2, wherein the PSCCH resource has a length of two symbols, and wherein the PSSCH resource has a length greater than ten symbols.

Aspect 5. The first network device of any of claims 1-4, wherein the S-SSB has a length of six symbols.

Aspect 6. The first network device of any of claims 1-5, wherein the at least one processor is further configured to: multiplex a first sidelink secondary synchronization signal (SSSS) in a physical sidelink broadcast channel (PSBCH) of the S-SSB.

Aspect 7. The first network device of claim 6, wherein the at least one processor is further configured to: multiplex a second sidelink secondary synchronization signal (SSSS) in the physical sidelink broadcast channel (PSBCH) of the S-SSB, wherein the first SSSS and second SSSS are multiplexed into different symbols of the PSBCH.

Aspect 8. The first network device of claim 7, wherein the PSBCH has a length of three symbols.

Aspect 9. The first network device of claim 7, wherein the PSBCH has a length of four symbols.

Aspect 10. The first network device of claim 9, wherein the S-SSB has a length of seven symbols.

Aspect 11. The first network device of any of claims 1-10, wherein the first network device is implemented as a first user equipment (UE), and further comprising: at least one transceiver configured to transmit the generated S-SSB.

Aspect 12. The first network device of claim 11, wherein the second network device comprises a second UE.

Aspect 13. A first network device for wireless communications, comprising: at least one memory comprising instructions; and at least one processor coupled to the at least one memory and configured to: receive, form a second network device, a sidelink synchronization block (S-SSB), the S-SSB including at least two sidelink primary synchronization signal (SPSS) symbols; and decode at least one of the two SPSS symbols to obtain at least one of timing information or frequency information.

Aspect 14. The first network device of claim 13, wherein the at least one processor is further configured to: detect a sidelink secondary synchronization signal (SSSS) based on at least one of the timing information or the frequency information; decode the SSSS to obtain a physical cell identifier of the second network device; and connect to the second network device based on at least one of the timing information or the frequency information and the physical cell identifier.

Aspect 15. The first network device any of claims 13-14, wherein the S-SSB is multiplexed with at least one of a physical sidelink control channel (PSCCH) resource or a physical sidelink shared channel (PSSCH) resource.

Aspect 16. The first network device of claim 15, wherein the PSCCH resource has a length of two symbols, and wherein the PSSCH resource has a length greater than ten symbols.

Aspect 17. The first network device of any of claims 13-16, wherein a leading symbol of the S-SSB comprises an automatic gain control (AGC) symbol.

Aspect 18. The first network device of any of claims 13-17, wherein the S-SSB has a length of six symbols.

Aspect 19. The first network device of any of claims 13-18, wherein a first sidelink secondary synchronization signal (SSSS) is multiplexed in a physical sidelink broadcast channel (PSBCH) of the S-SSB.

Aspect 20. The first network device of claim 19, wherein a second SSSS is multiplexed in the PSBCH, and wherein the first SSSS and second SSSS are multiplexed into different symbols of the PSBCH.

Aspect 21. The first network device of claim 20, wherein the PSBCH has a length of four symbols.

Aspect 22. The first network device of claim 21, wherein the S-SSB has a length of seven symbols.

Aspect 23. A method for wireless communications, comprising: generating a sidelink synchronization block (S-SSB), the S-SSB including at least two sidelink primary synchronization signal (SPSS) symbols; and transmitting, to a second network device, the generated S-SSB.

Aspect 24. The method of claim 23, further comprising multiplexing the S-SSB with at least one of a physical sidelink control channel (PSCCH) resource or physical sidelink shared channel (PSSCH) resource, wherein transmitting the generated S-SSB comprises transmitting the multiplexed S-SSB with at least one of the PSCCH resource or the PSSCH resource to the second network device.

Aspect 25. The method of claim 24, wherein a leading symbol of the multiplexed S-SSB comprises an automatic gain control (AGC) symbol.

Aspect 26. The method of claim 24, wherein the PSCCH resource has a length of two symbols, and wherein the PSSCH resource has a length greater than ten symbols.

Aspect 27. The method of any of claims 23-26, wherein the S-SSB has a length of six symbols.

Aspect 28. The method of any of claims 23-27, further comprising multiplexing a first sidelink secondary synchronization signal (SSSS) in a physical sidelink broadcast channel (PSBCH) of the S-SSB.

Aspect 29. The method of claim 28, further comprising multiplexing a second sidelink secondary synchronization signal (SSSS) in the physical sidelink broadcast channel (PSBCH) of the S-SSB, wherein the first SSSS and second SSSS are multiplexed into different symbols of the PSBCH.

Aspect 30. The method of claim 28, wherein the PSBCH has a length of three symbols.

Aspect 31. The method of claim 28, wherein the PSBCH has a length of four symbols.

Aspect 32. The method of claim 31, wherein the S-SSB has a length of seven symbols.

Aspect 33. The method of claim 23, wherein the method is implemented as a first user equipment (UE) and wherein the first UE includes at least one transceiver for transmitting the generated S-SSB.

Aspect 34. The method of claim 33, wherein the second network device comprises a second UE.

Aspect 35. A method for wireless communications, comprising: receiving, form a second network device, a sidelink synchronization block (S-SSB), the S-SSB including at least two sidelink primary synchronization signal (SPSS) symbols; and decoding at least one of the two SPSS symbols to obtain at least one of timing information or frequency information.

Aspect 36. The method of claim 35, further comprising: detecting a sidelink secondary synchronization signal (SSSS) based on at least one of the timing information or the frequency information; decoding the SSSS to obtain a physical cell identifier of the second network device; and connecting to the second network device based on at least one of the timing information or the frequency information and the physical cell identifier.

Aspect 37. The method of any of claims 35-37, wherein the S-SSB is multiplexed with at least one of a physical sidelink control channel (PSCCH) resource or a physical sidelink shared channel (PSSCH) resource.

Aspect 38. The method of claim 37, wherein the PSCCH resource has a length of two symbols, and wherein the PSSCH resource has a length greater than ten symbols.

Aspect 39. The method of any of claims 35-39, wherein a leading symbol of the S-SSB comprises an automatic gain control (AGC) symbol.

Aspect 40. The method of any of claims 35-39, wherein the S-SSB has a length of six symbols.

Aspect 41. The method of any of claims 35-40, wherein a first sidelink secondary synchronization signal (SSSS) is multiplexed in a physical sidelink broadcast channel (PSBCH) of the S-SSB.

Aspect 42. The method of claim 41, wherein a second SSSS is multiplexed in the PSBCH, and wherein the first SSSS and second SSSS are multiplexed into different symbols of the PSBCH.

Aspect 43. The method of claim 42, wherein the PSBCH has a length of four symbols.

Aspect 44. The method of claim 43, wherein the S-SSB has a length of seven symbols

Aspect 31. At least one non-transitory computer-readable medium containing instructions which, when executed by one or more processors, cause the one or more processors to perform a method according to any of Aspects 23 to 44.

Aspect 32. An apparatus comprising means for performing a method according to any of Aspects 23 to 44.

1. A first network device for wireless communications, comprising:
at least one memory comprising instructions; and
at least one processor coupled to the at least one memory and configured to:
generate a sidelink synchronization block (S-SSB), the S-SSB including at least two sidelink primary synchronization signal (SPSS) symbols; and
transmit, to a second network device, the generated S-SSB.

2. The first network device of claim 1, wherein:
the at least one processor is further configured to multiplex the S-SSB with at least one of a physical sidelink control channel (PSCCH) resource or physical sidelink shared channel (PSSCH) resource; and
to transmit the generated S-SSB, the at least one processor is further configured to transmit the multiplexed S-SSB with at least one of the PSCCH resource or the PSSCH resource to the second network device.

3. The first network device of claim 2, wherein a leading symbol of the multiplexed S-SSB comprises an automatic gain control (AGC) symbol.

4. The first network device of claim 2, wherein the PSCCH resource has a length of two symbols, and wherein the PSSCH resource has a length greater than ten symbols.

5. The first network device of claim 1, wherein the S-SSB has a length of six symbols.

6. The first network device of claim 1, wherein the at least one processor is further configured to:
multiplex a first sidelink secondary synchronization signal (SSSS) in a physical sidelink broadcast channel (PSBCH) of the S-SSB.

7. The first network device of claim 6, wherein the at least one processor is further configured to:
multiplex a second sidelink secondary synchronization signal (SSSS) in the physical sidelink broadcast channel (PSBCH) of the S-SSB, wherein the first SSSS and second SSSS are multiplexed into different symbols of the PSBCH.

8. The first network device of claim 7, wherein the PSBCH has a length of three symbols.

9. The first network device of claim 7, wherein the PSBCH has a length of four symbols.

10. The first network device of claim 9, wherein the S-SSB has a length of seven symbols.

11. The first network device of claim 1, wherein the first network device is implemented as a first user equipment (UE), and further comprising:
at least one transceiver configured to transmit the generated S-SSB.

12. The first network device of claim 11, wherein the second network device comprises a second UE.

13. A first network device for wireless communications, comprising:
at least one memory comprising instructions; and
at least one processor coupled to the at least one memory and configured to:
receive, form a second network device, a sidelink synchronization block (S-SSB), the S-SSB including at least two sidelink primary synchronization signal (SPSS) symbols; and
decode at least one of the two SPSS symbols to obtain at least one of timing information or frequency information.

14. The first network device of claim 13, wherein the at least one processor is further configured to:
detect a sidelink secondary synchronization signal (SSSS) based on at least one of the timing information or the frequency information;
decode the SSSS to obtain a physical cell identifier of the second network device; and
connect to the second network device based on at least one of the timing information or the frequency information and the physical cell identifier.

15. The first network device of claim 13, wherein the S-SSB is multiplexed with at least one of a physical sidelink control channel (PSCCH) resource or a physical sidelink shared channel (PSSCH) resource.

16. The first network device of claim 15, wherein the PSCCH resource has a length of two symbols, and wherein the PSSCH resource has a length greater than ten symbols.

17. The first network device of claim 13, wherein a leading symbol of the S-SSB comprises an automatic gain control (AGC) symbol.

18. The first network device of claim 13, wherein the S-SSB has a length of six symbols.

19. The first network device of claim 13, wherein a first sidelink secondary synchronization signal (SSSS) is multiplexed in a physical sidelink broadcast channel (PSBCH) of the S-SSB.

20. (canceled)

21. (canceled)

22. (canceled)

23. A method for wireless communications, comprising:
generating a sidelink synchronization block (S-SSB), the S-SSB including at least two sidelink primary synchronization signal (SPSS) symbols; and
transmitting, to a second network device, the generated S-SSB.

24.-30. (canceled)
